(19) United States
(12) Patent Application Publication
(10) Pub. No.: US 2007/0046426 A1
(43) Pub. Date: Mar. 1, 2007

(54) Admittance management system and admittance management method

(75) Inventor: Yuuichiro Ishibashi, Tokyo (JP)

Correspondence Address: PILLSBURY WINTHROP SHAW PITTMAN, LLP, P.O. BOX 10500, MCLEAN, VA, 22102, US

(73) Assignee: KABUSHIKI KAISHA TOSHIBA, Tokyo (JP)

(21) Appl. No.: 11/509,743

(22) Filed: Aug. 25, 2006

(30) Foreign Application Priority Data
Aug. 26, 2005 (JP) 2005-246143

(51) Int. Cl. G05B 19/00; G05B 23/00

(52) U.S. Cl. 340/5.52; 382/115; 340/5.82

(57) ABSTRACT

In an admittance management system, an admission ticket to a security area is issued, biometric information of a person who has performed an issuing procedure of the admission ticket is acquired as first biometric information, biometric information of a person who has approached a gate provided at an entrance to the security area is acquired as second biometric information, a judgment is made upon whether the biometric information of the person who has approached the gate and the biometric information of the person who has performed the issuing procedure of the admission ticket do not correspond to the same person, and the person is allowed to pass through the gate when it is determined that the biometric information of the person who has approached the gate and the biometric information of the person who has performed the issuing procedure of the admission ticket correspond to the same person.

### CROSS-REFERENCE TO RELATED APPLICATIONS

This application is based upon and claims the benefit of priority from prior Japanese Patent Application No. 2005-246143, filed Aug. 26, 2005, the entire contents of which are incorporated herein by reference.

### BACKGROUND OF THE INVENTION

1. Field of the Invention

The present invention relates to an admittance management system and an admittance management method which manage visitors by using biometric information such as facial images of persons.

2. Description of the Related Art

An admittance management system is a system which manages visitors to a security area (a room, a facility and others). As the admittance management system, there is on which manages admission of a person by using biometric information such as a facial image of the person. The admittance management system which manages admittance of persons by using facial images has a camera such as a video camera, a dictionary in which facial images of persons who gained admission in advance are registered, and others. The admittance management system images a face of a person who is going to get admittance to a security area by the camera, and collates a facial image shot by the camera with a facial image registered in the dictionary. When the facial image shot by the camera matches with the facial image of the person registered in the dictionary, the admittance management system allows entry of this visitor, and unlocks an entrance door (a gate device) to the security area (see, e.g., Jpn. Pat. Appln. KOKAI Publication No. 2000-331207).

Further, in a conventional admittance management system, avoiding fraudulent admittance based on substitution of persons may be difficult in some cases. For example, a passenger who gets on board a passenger plane is identified in a boarding procedure or a departure procedure. However, the passenger which has been identified in the boarding procedure or the departure procedure waits in a waiting room until he/she gets on board the passenger plane. Usually, users heading for various destinations (passengers of different passenger planes) exist in this waiting room. Therefore, there is a possibility that a plurality of passengers may exchange their boarding tickets, substitute for other persons and fraudulently get on board a passenger plane which is different from the original target plane. In the present circumstances, detecting exchange of passenger tickets is difficult. Further, completely separating passengers in accordance with each passenger plane is difficult because of a structure of an airport or the like. Therefore, under existing conditions, air marshals visually identify persons (confirm, e.g., IDs such as passports and boarding tickets) in some places. In this case, the air marshals must confirm all passengers, a working burden or a time loss is large.

### BRIEF SUMMARY OF THE INVENTION

According to one aspect of the present invention, there is provided an admittance management system and an admittance management method which can effectively detect fraudulent admittance to a security area or illegal visitors in the security area.

According to one aspect of the present invention, there is provided an admittance management system comprises a ticketing section which issues an admission ticket to a security area, a first biometric information acquiring section which acquires biometric information of a person subjected to a ticketing procedure of the admission ticket by the ticking section, a second biometric information acquiring section which acquires biometric information of a person who has approached a gate provided at an entrance to the security area, a judging section which judges whether the biometric information acquired by the second biometric information acquiring section and the biometric information acquired by the first biometric information acquiring section correspond to the same person, and a gate control section which allows passage of the person through the gate, when the judgment section determines that the biometric information acquired by the second biometric information acquiring section and the biometric information acquired by the first biometric information acquiring section correspond to the same person.

Additional objects and advantages of the invention will be set forth in the description which follows, and in part will be obvious from the description, or may be learned by practice of the invention. The objects and advantages of the invention may be realized and obtained by means of the instrumentalities and combinations particularly pointed out hereinafter.

### BRIEF DESCRIPTION OF THE SEVERAL VIEWS OF THE DRAWING

The accompanying drawings, which are incorporated in and constitute a part of the specification, illustrate embodiments of the invention, and together with the general description given above and the detailed description of the embodiments given below, serve to explain the principles of the invention.

FIG. 1 is a schematic view schematically showing a configuration of an admittance management system according to a first embodiment;

FIG. 2 is a block diagram schematically showing a structural example of each device constituting the admittance management system according to the first embodiment;

FIG. 3 is a flowchart illustrating boarding procedure processing by a ticketing device in the admittance management system according to the first embodiment;

FIG. 4 is a flowchart illustrating passage control processing by a gate device in the admittance management system according to the first embodiment;

FIG. 5 is a flowchart illustrating face matching processing by a matching device in the admittance management system according to the first embodiment;

FIG. 6 is a flowchart illustrating list retrieval processing in the admittance management system according to the first embodiment;

FIG. 7 schematically shows an entire configuration of an admittance management system according to a second embodiment;

FIG. 8 is a block diagram schematically showing a structural example of each device constituting the admittance management system according to the second embodiment;

FIG. 9 is a flowchart illustrating membership registration procedure processing by a membership registering device in the admittance management system according to the second embodiment;

FIG. 10 is a flowchart illustrating an example of flight reservation processing by a reservation information managing device using a user terminal in the admittance management system according to the second embodiment;

FIG. 11 is a flowchart illustrating boarding procedure processing based on reservation information by a ticketing device in the admittance management system according to the second embodiment;

FIG. 12 schematically shows a configuration of an admittance management system according to a third embodiment;

FIG. 13 is a block diagram schematically showing a structural example of each device constituting the admittance management system according to the third embodiment;

FIG. 14 shows a display example in a display section of a terminal device in the admittance management system according to the third embodiment;

FIG. 15 is a flowchart illustrating face matching processing by a matching device in the admittance management system according to the third embodiment; and

FIG. 16 schematically shows an entire structure of an admittance management system according to a fourth embodiment.

### DETAILED DESCRIPTION OF THE INVENTION

Embodiments according to the present invention will now be described hereinafter.

A system described below is an admittance management system which monitors a “person who is going to get admittance” or a “person who has got admittance” to a security area. Further, the admittance management system monitors a person based on biometric information of this person. It is to be noted that the following describes the admittance management system which uses a facial image as biometric information of each person. However, the admittance management system can be realized by using facial images as well as other biometric information such as fingerprint images, iris information, palm shape images, finger images, vein information or voice information. Furthermore, in the following description, an admittance management system which manages boarding (admittance) to a passenger plane (a security area) is assumed as an example of the admittance management system.

A first embodiment will be first explained.

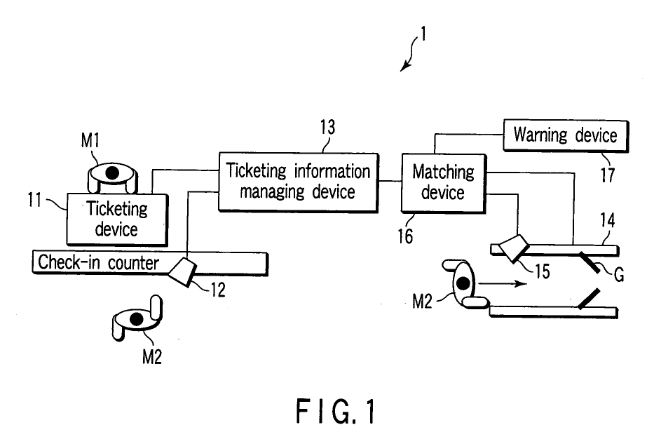

FIG. 1 schematically shows an entire configuration of an admittance management system 1 according to the first embodiment.

The admittance management system 1 shown in FIG. 1 is constituted of a ticketing device (a boarding procedure device) 11, a camera 12, a ticketing information management device 13, a gate device (a passage control device) 14, a camera 15, a matching device 16, a warning device 17 and others. Incidentally, as described above, as the admittance management system 1 according to the first embodiment, one which is set in an airport or the like and manages admittance (boarding) to a passenger plane is assumed. That is, it is assumed that the inside of the passenger plane is a security area.

The ticketing device 11 is a device which performs a passenger procedure of each person (each passenger) M2 who gets on board a passenger plane. Moreover, the ticketing device 11 is a device which issues a boarding ticket (an admittance ticket) as a boarding procedure to a person who gets on board (gets admittance to) the passenger plane (a security area). That is, the ticketing device 11 issues a boarding ticket in accordance with each person (each passenger) M2 who has been through the boarding procedure with respect to the passenger plane. The ticketing device 11 is set at, e.g., a check-in counter in an airport or the like. In this case, the ticketing device 11 performs the boarding procedure of the passenger (a visitor) M2 who gets on board (gets admittance to) the passenger plane (an admittance target area) and issues a boarding ticket (an admittance ticket) of the passenger (the visitor) M2 which has finished the boarding procedure by an operation of an attendant (a staff of an airline company) M1. It is to be noted that the ticketing device 11 may perform the boarding procedure and issue the boarding ticket by an operation of each passenger himself/herself.

Additionally, boarding ticket information such as a ticket number of a boarding ticket, a name of a passenger, a flight number of a passenger plane or a seat number is recorded on a boarding ticket issued by the ticketing device 11. The boarding ticket may be a recording medium having a magnetic recording section or a recording medium having a built-in recording portion such as an IC chip. Further, the ticketing device 11 may record the boarding ticket information in an electronic device such as a mobile phone or an IC card of a user as ticketing processing of the boarding ticket. In this case, the electronic device in which the boarding ticket information is recorded is utilized as a boarding ticket.

The camera 12 is a device which shoots a facial image (an image including at least a face) of a passenger whose boarding procedure is currently carried out by the ticketing device 11. Here, the facial image shot by the camera 12 is referred to as a first facial image. The camera 12 functions as a first facial image acquiring device (first biometric information acquiring means). The camera 12 is set in the vicinity of, e.g., the ticketing device 11. That is, the camera 12 acquires the first facial image as biometric information of the passenger M2 who is currently subjected to the boarding procedure (boarding ticket issuing processing) by the ticketing device 11. The first facial image of the passenger M2 shot by the camera 12 is supplied to the ticketing device 11. The ticketing device 11 supplies information such as a ticket number of the boarding ticket, a name of the passenger, a flight number of the passenger plane or a seat number as well as the first facial image as passenger information to the ticketing information managing device 13.

The ticketing information managing device 13 is a device which manages passenger information or the like. The ticketing information managing device 13 is connected to the ticketing device 11, the gate device 14, the matching device 16, the warning device 17 and others through a communication line. The ticketing information managing device 13 has a function of storing the passenger information from the ticketing device 11 and distributes it to the matching device 16, for example.

The gate device 14 is provided at a boarding gate (an entrance) to get on board the passenger plane. The gate device 14 is a device which judges whether admittance (passage through the boarding gate) of the passenger M2 is possible. The gate device 14 has a function of reaching the passenger information recorded on the boarding ticket owned by the passenger M2. Furthermore, the gate device 14 has a gate G which avoids passage through the boarding gate. Opening/closing of the gate G is controlled by a main body of the gate device 14. For example, when the gate device 14 determines that boarding of the passenger. M2 who has presented the boarding ticket is allowed, it controls the gate G to be opened. When the gate device 14 determines that boarding of the passenger M2 who has presented the boarding ticket is not allowed, it controls the gate G to be closed and notifies the warning device 17.

That is, the gate device 14 judges whether admittance (passage through the boarding gate) of the passenger M2 who has presented the boarding ticket is allowed, and controls admittance (passage through the boarding gate) to the passenger plane by controlling opening/closing of the gate G based on a result of this judgment. Moreover, the gate device 14 also judges whether admittance to the passenger plane (passage through the boarding gate) is permitted based on validity of the boarding ticket presented by the passenger, a result of matching of facial images of the passenger by the matching device 16 (a result of collating the first facial image with the second facial image) and others.

The camera 15 is a device which shoots a facial image of a person (a passenger) M2 who is going to pass through the boarding gate (acquires biometric information) Here, the facial image shot by the camera 15 is referred to as a second facial image. The camera 15 functions as a second facial image acquiring device (a second biometric image acquiring section). The camera 15 is set in the vicinity of, e.g., the gate G. The second facial image of the passenger M2 taken by the camera 15 is supplied to the gate device 14.

The matching device 16 is a device which performs matching processing of facial images. The matching device 16 collates the first facial image shot by the camera 21 when the boarding ticket is issued with the second facial image shot by the camera 15. The first facial image shot by the camera 15 at the time of the boarding procedure (when the boarding ticket is issued) is stored as passenger information in the ticketing information managing device 13. That is, the ticketing information managing device 13 can retrieve the passenger information including the first facial image shot by the camera 12 based on the boarding ticket information read from the boarding ticket in the gate device 14.

That is, when the boarding ticket information and the second facial image shot by the camera 15 are supplied from the gate device 14 to the matching device 16, the matching device 16 acquires the first facial image shot by the camera 12 from the ticketing information managing device 13 based on the boarding ticket information. When the ticketing information managing device 13 acquires the first facial image corresponding to the boarding ticket information, the matching device 16 collates the first facial image with the second facial image received from the gate device 14. Additionally, the matching device 16 transmits a result of matching of the first facial image and the second facial image to the gate device 14.

The warning device 17 is a device which informs the attendant or the passenger himself/herself of a warning. When information indicating that boarding is impossible is received from the gate device 14, the warning device 17 sends out a warning or displays information that boarding is not allowed in a display section. Further, the warning device 17 may display information concerning a person who is not allowed to get on board by the gate device 14. For example, the warning device 17 may align and display in the display section a facial image (the second facial image) who is not allowed to get on board shot by the camera 15 and a facial image (the first facial image) in the boarding procedure corresponding to boarding ticket information owned by this person.

A description will now be given as to a structural example of each device (the ticketing device 11, the camera 12, the ticketing information managing device 13, the gate device 14, the camera 15, the matching device 16 or the warning device 17) constituting the admittance management system 1.

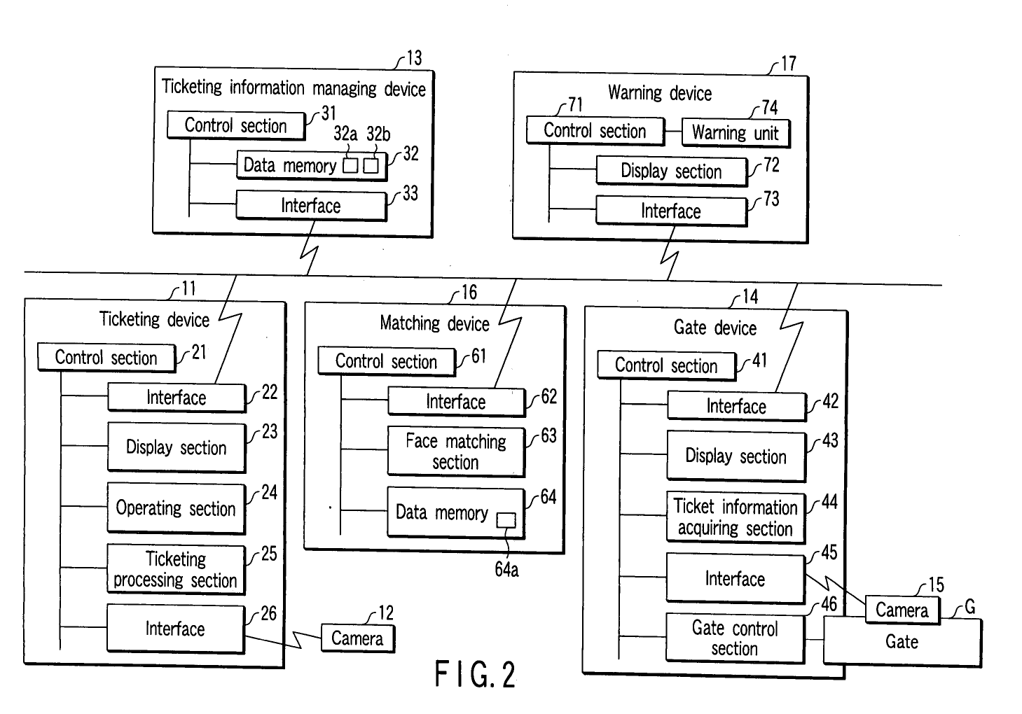

FIG. 2 is a block diagram schematically showing a structural example of each device constituting the admittance management system 1. As shown in FIG. 2, in the admittance management system 1, the ticketing device 11, the ticketing information managing device 13, the gate device 14, the matching device 16, the warning device 17 and others are connected through a network 18. Furthermore, the camera 12 is connected with the ticketing device 11. The camera 15 is connected with the gate device 14 (or the matching device 16).

A structural example of the ticketing device 11 will be first explained.

As shown in FIG. 2, the ticketing device (a boarding procedure device) 11 has a control section 21, an interface 22, a display section 23, a operating section 24, a ticketing processing section 25, an interface 26 and others.

The control section 21 controls the entire ticketing device 11. The control section 21 is constituted of a CPU as an arithmetic operating section, an RAM and an ROM as memories and various kinds of interfaces or the like which connect respective portions in this device. The control section 21 is configured to realize various kinds of processing by executing a control program or the like stored in memories.

The interface 22 is an interface which performs data communication with each device (the ticketing information managing device 13, the gate device 14, the matching device 16 or the warning device 17) through the network 18. That is, the interface 22 functions as a communicating section which carries out data communication with each device.

The display section 23 is a device which displays guidance or the like of the boarding procedure. The operating section 24 is a device to which information is input by an attendant or a user. The operating section 24 is constituted of various kinds of operation keys or the like. For example, the display section 23 and the operating section 24 are formed of a liquid crystal display device having a built-in touch panel or the like.

The ticketing processing section 25 carries out ticketing processing of a boarding ticket. For example, in case of issuing a boarding ticket in which boarding ticket information is recorded in a recording medium having a magnetic or IC recording portion, the ticketing processing section 25 records the boarding ticket information in the recording portion of the recording medium or prints the boarding ticket information on a surface of the recording medium. Moreover, in an operational conformation where boarding ticket information is recorded in an electronic device owned by a user (e.g., a portable terminal device having a non-contact type IC card or a non-contact type wireless communicating function), the ticketing processing portion 25 is configured to record the boarding ticket information in the electronic device owned by the user.

The interface 26 is an interface which acquires a facial image (the first facial image) as biometric information (the first biometric information) of a person who is currently subjected to the boarding procedure. In the structural example shown in FIG. 1 or FIG. 2, the interface 26 is connected with the camera 12, and functions as an image input interface which acquires a facial image (the first facial image) of a person who is currently subjected to the boarding procedure shot by the camera 12.

A structural example of the ticketing information managing device 13 will now be described.

As shown in FIG. 2, the ticketing information managing device 13 has a control section 31, a data memory 32, an interface 33 and others.

The control section 31 controls the entire ticketing information managing device 13. The control section 31 is constituted of a CPU as an arithmetic operating section, an RAM and an ROM as memories, various kinds of interfaces which connect respective portions in this device, and others. The control section 31 is configured to realize various kinds of processing by executing a control program or the like stored in the memories. For example, the control section 31 has a function of retrieving information stored in the data memory 32 based on information which is a retrieval key. Furthermore, the control section 31 also has a function of retrieving the first facial image corresponding to the boarding ticket information in accordance with a retrieval request for the first facial image based on the boarding ticket information from the matching device 16, and returning the first facial image as a result of this retrieval to the matching device 16.

The data memory 32 is constituted of a high-capacity storage device such as a hard disk drive. The data memory 32 has a database 32a which stores passenger information, boarding ticket information or the like in the admittance management system. Passenger information including a facial image of each passenger at the time of the boarding procedure and boarding ticket information recorded on each issued boarding ticket are stored in association with each other in the database 32a. As a result, the passenger information stored in the database 32a can be retrieved based on the boarding ticket information.

Further, the data memory 32 stores list data 32b consisting of information including at least a facial image of a specific person. The list data 32b is data stored in the data memory 32 in advance. Here, the specific person means, e.g., a marked person who is on a black list (e.g., a wanted list) or a white list (a list of passengers or the like who need special services). That is, the list data 32b is used as a black list or a white list in the admittance management system, and information including at least a facial image of a specific person is configured in the form of a list.

The interface 33 is an interface which performs data communication with each device (the ticketing device 11, the gate device 14, the matching device 16 or the warning device 17) through the network 18. That is, the interface 33 functions as a communicating section which carries out data communication with each device.

A structural example of the data device 14 will now be described.

As shown in FIG. 2, the gate device (a passage control device) 14 has a control section 41, an interface 42, a display section 43, a boarding ticket information acquiring section 44, an interface 45, a gate control section 46 and others.

The control section 41 controls the entire gate device 14. The control section 41 is constituted of a CPU as an arithmetic operating section, an RAM and an ROM as memories, various kinds of interfaces which connect respective sections in this device, and others. The control section 41 is configured to realize various kinds of processing by executing a control program or the like stored in memories. For example, in the control section 41, processing of judging whether passage is possible is realized by the control program.

The interface 42 is an interface which performs data communication with each device (the ticketing device 11, the ticketing information managing device 13, the matching device 16 or the warning device 17) through the network 18. That is, the interface 42 functions as a communicating section for effecting data communication with each device.

The display section 43 is a device which displays guidance or the like when a person passes through the gate G. The display section 23 is constituted of, e.g., a liquid crystal display device set in the vicinity of the gate G.

The boarding ticket information acquiring section 44 acquires boarding ticket information. For example, when a user owns a boarding ticket in which boarding ticket information is recorded in a magnetic or IC recording portion, the boarding ticket information acquiring section 44 is formed of a read device which reads the boarding ticket information from the recording portion of the boarding ticket presented by the user. Further, when a user has an electronic device such as a portable terminal in which boarding ticket information is recorded, the boarding ticket information acquiring section 44 is constituted of a read device which reads the boarding ticket information from the electronic device owned by the user.

The interface 45 is an interface which acquires a facial image (the second facial image) as biometric information (the second biometric information) of a person who is going to pass through the gate G. In the structural example in FIG. 2, the interface 45 is connected with the camera 15, and functions as an image input interface which acquires a facial image (the second facial image) of a person which has approached the gate G shot by the camera 15.

The gate control section 46 is a device which controls opening/closing of the gate G. That is, the gate control section 46 opens the gate G in accordance with an instruction to open the gate from the control section 41, and closes the gate G in response to an instruction to close the gate from the control section 41.

A structural example of the matching device 16 will now be described.

As shown in FIG. 2, the matching device 16 has a control section 61, an interface 62, a face matching section 63 and others.

The control section 61 controls the entire matching device 16. The control section 61 is constituted of a CPU as an arithmetic operating section, an RAM and an ROM as memories, various kinds of interfaces which connect respective sections in this device and others. The control section 61 is configured to realize various kinds of processing by executing a control program or the like stored in memories.

The interface 62 is an interface which performs data communication with each device (the ticketing device 11, the ticketing information managing device 13, the gate device 14 or the warning device 17) through the network 18. That is, the interface 62 functions as a communicating section which carries out data communication with each device.

The face matching section 63 is a device which collates two facial images with each other. That is, the face matching section 63 performs matching to judge whether two facial images correspond to the same person (whether two facial images match with each other). In this first embodiment, the face matching section 63 collates a facial image (the first facial image) shot by the camera 12 with a facial image (the second facial image) shot by the camera 15. The second facial image is supplied from the gate device 14 to the matching device 16. Moreover, the first facial image is associated with boarding ticket information and recorded in the ticketing information managing device 13 as passenger information. Therefore, the first facial image can be retrieved in the ticketing information managing device 13 based on the boarding ticket information supplied to the matching device 16 from the gate device 14.

That is, the matching device 16 acquires from the ticketing information managing device 13 the first facial image corresponding to the boarding ticket information which has been supplied together with the second facial image shot by the camera 15 and read by the gate device 14. As a result, the face matching section 63 judges whether the first facial image and the second facial image are facial images of the same person. The gate device 14 is notified of a result of face matching by the face matching section 63 through the interface 62 based on control by the control section 61.

The data memory 64 is constituted of a high-capacity storage device such as a hard disk drive. The data memory 64 stores list data 64a consisting of information including at least a facial image concerning a specific person. The list data 64a is data stored in the data memory 64 in advance. Here, the specific person means, e.g., a marked person who is on a black list (e.g., a wanted list) or a white list (a list of passengers or the like who need special services). That is, the list data 64a is used as a black list or a white list, and information including at least a facial image of a specific person is configured in the form of a list.

It is to be noted that the list data 64a may be the same as the list data 32b stored in the data memory 32 of the ticketing information managing device 13, or may be a part of the list data 32b required in the matching device 16. Further, the list data 64a may be downloaded from the list data 32b of the ticketing information managing device 13 and stored in the data memory 64 as required.

A structural example of the warning device 17 will now be described.

As shown in FIG. 2, the warning device 17 has a control section 71, a display section 72, an interface 73, a warning unit 74 and others.

The control section 71 controls the entire warning device 17. The control section 71 is constituted of a CPU as an arithmetic operating section, an RAM and an ROM as memories, various kinds of interfaces which connect respective portions in this device, and others. The control section 71 is configured to realize various kinds of processing by executing a control program or the like stored in the memories.

The display section 72 displays various kinds of guidance. For example, when the gate device 14 determines that passage through the gate is not allowed, a warning message indicating that passage through the gate is not allowed is displayed in the display section 72. At this time, information concerning a person who is not allowed to pass through the gate may be displayed in the display section 72.

The interface 73 is an interface which performs data communication with each device (the ticketing device 11, the ticketing information managing device 13, the gate device 14 or the matching device 16) through the network 18. That is, the interface 73 functions as a communicating section which carries out data communication with each device.

The warning unit 74 is a device which gives a warning. The warning unit 74 may give a warning sound or may turn on a warning light.

The hardware configuration of the admittance management system can be modified in many ways in accordance with operational conformations. For example, the gate device 14 and the matching device 16 may be configured as a single integrated device. Moreover, the data device 14, the matching device 16 and the warning device 17 may be configured as a single integrated device.

Processing in each device constituting the admittance management system 1 will now be described.

Boarding procedure processing by the ticketing device (the boarding procedure device) 11 will be first explained.

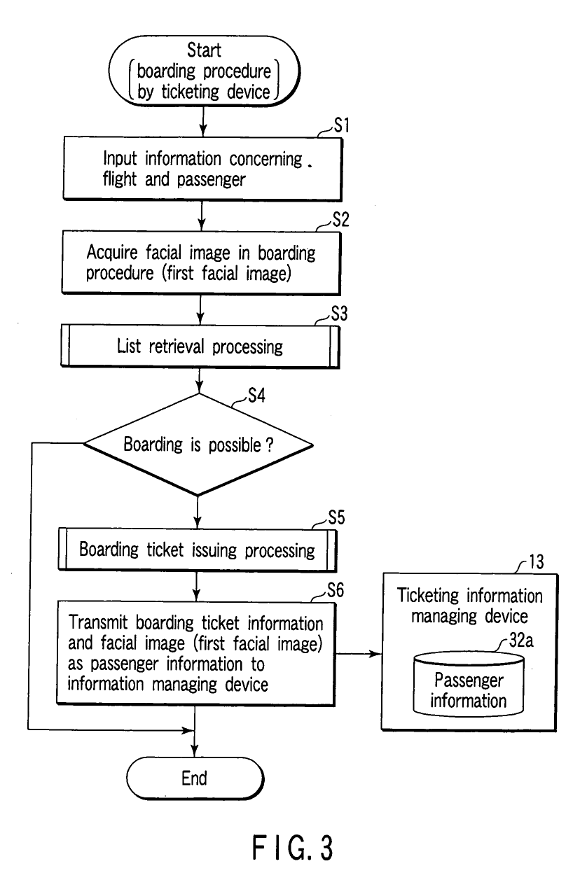

FIG. 3 is a flowchart illustrating the boarding procedure processing by the ticketing device 11.

A person (a passenger) who wants to get on board a passenger plane is first subjected to a boarding procedure by the ticketing device 11. The boarding procedure may be performed by the ticketing device 11 which is installed in a check-in counter in an airport or the like and manipulated by an attendant, or the ticketing device 11 which is installed at a predetermined position and operated by the passenger himself/herself. Here, a description will be given on the assumption that the boarding procedure is performed by the ticketing device 11 which is installed in a check-in counter in an airport or the like and manipulated by an attendant.

That is, the passenger M2 who went to the check-in counter informs the attendant of information required for the boarding procedure. Then, the attendant sequentially inputs the information required for the boarding procedure by manipulating the operating section 24 of the ticketing device 11 (a step S1). While inputting the information required for the boarding procedure, or when input of the information required for the boarding procedure is completed, the camera 12 takes a facial image (the first facial image) of the passenger M2. The ticketing device 11 acquires the first facial image shot by the camera 12 through the interface 26 (a step S2).

When the first facial image is acquired through the interface 26, the control section 21 of the ticketing device 11 requests the matching device 16 to perform list retrieval processing based on the first facial image (a step S3). In this case, the control section 21 of the ticketing device 11 transmits a request of the list retrieval processing based on the first facial image together with the first facial image to the matching device 16, and receives a result of the list retrieval processing from the matching device 16.

Additionally, in the list retrieval processing by the matching device 16, degrees of similarity of the first facial image and facial images of all specific persons registered in the list data 64a are calculated, and a predetermined number of facial images aligned in a descending order of the degrees of similarity with respect to the first facial image are determined as a result of the retrieval. It is to be noted that the list retrieval processing may judge whether a maximum one of degrees of similarity of the first facial image and respective facial images in the list data 64a is not smaller than a predetermined threshold value. In this case, the list retrieval processing determines which person registered in the list data 64a corresponds to the person having the first facial image.

It is to be noted that the ticketing device 11 may execute the list retrieval processing based on the first facial image by providing a face matching section in the ticketing device 11. In this case, the list data 64a may be stored in a non-illustrated memory in the ticketing device 11 in advance, or may be downloaded from the ticketing information managing device 13 or the matching device 16.

The control section 21 of the ticketing device 11 judges whether the passenger satisfies conditions to get on board based on the information input through the operating section 24, the first facial image acquired through the interface 26, a result of the list retrieval processing or the like (a step S4). For example, when all information required for the boarding procedure is input through the operating section 24 and it is determined that the facial image (the first facial image) of the passenger M2 does not correspond to a person who is not allowed to get on board by the list retrieval processing through the interface 26, the control section 21 determines to allow the passenger to get on board.

When it is determined that boarding of the passenger is allowed by the judgment (the step S4, YES), the control section 21 performs ticketing processing of a boarding ticket with respect to the passenger through the ticketing processing section 25 (a step S5). In this ticketing processing, for example, a recording medium in which boarding ticket information such as a name of the passenger, a flight number of a passenger plane, a seat number and others is recorded is issued as a boarding ticket. Incidentally, in an operational conformation where an electronic device owned by a user can substitute for the boarding ticket, it is good enough to record the boarding ticket information in the electronic device owned by the user as the ticketing processing.

When the boarding ticket is issued by the ticketing processing, the control section 21 transmits the information (the boarding ticket information) recorded on the boarding ticket and the facial image (the first facial image) shot by the camera 12 as passenger information to the ticketing information managing device 13 (a step S6). The ticketing information managing device 13 which has received this passenger information records the passenger information in the database 32a. Further, the boarding ticket issued by the above-described ticketing processing is handed to the passenger from the attendant. According to the above-mentioned processing, the boarding procedure with respect to the passenger M2 is brought to completion.

Passage control processing by the gate device 14 will now be described.

The passenger who has been through the boarding procedure waits in a waiting room or the like until a time to get on board the target passenger plane. When the boarding time of the passenger plane is reached, the passenger goes to a boarding gate of the passenger plane with his/her boarding ticket. At this time, the gate device 14 provided at the boarding gate of the passenger plane executes passage control processing based on the boarding ticket information recorded on the boarding ticket owned by the passenger and the facial image of the passenger.

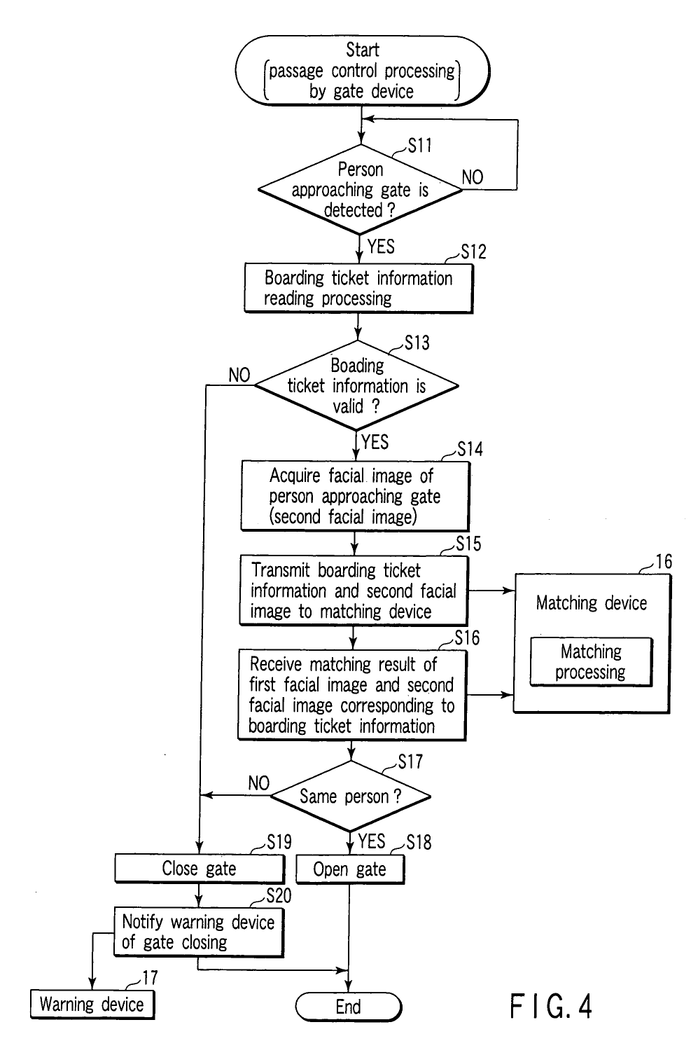

FIG. 4 is a flowchart illustrating the passage control processing by the gate device 14.

First, it is assumed that the passenger M2 has approached the boarding gate in order to get on board the passenger plane. The gate device 14 is provided at the boarding gate. The control section 14 of the gate device 14 detects whether a person is approaching the boarding gate based on a picture which is taken by the camera 15 and input through the interface 45 (a step S11). It is to be noted that the passenger who has approached the boarding gate may be detected by a sensor which detects each person.

When it is detected that the passenger M2 has approached the gate device 14 at the boarding gate (the step S11, YES), the control section 41 of the gate device 14 performs processing to read the boarding ticket information recorded in the boarding ticket owned by the passenger M2 through the boarding ticket information acquiring section 44 (a step S12). In case of a boarding ticket in which the boarding ticket information is recorded in a magnetic or IC recording portion, the boarding ticket information acquiring section 44 reads the boarding ticket information recorded in the boarding ticket put into a non-illustrated slot or the boarding ticket presented at a predetermined position. Furthermore, when the boarding ticket information is recorded in an electronic device (e.g., a portable terminal device having a non-contact type IC card or a non-contact type wireless communicating function) owned by a user, the boarding ticket information acquiring section 44 performs processing to read the boarding ticket information from the electronic device owned by the user.

When the boarding ticket information is read by the boarding ticket information acquiring section 44, the control section 41 judges whether the boarding ticket information is valid (a step S13). As the validity of boarding ticket information, the control section 41 judges whether the boarding ticket information is boarding ticket information for the passenger plane that the passenger gets on board from the boarding gate. When it is determined that the boarding ticket information is not valid as a result of this judgment (the step S13, NO), the control section 41 closes the gate G by using the gate control section 46 (a step S19). In this case, the control section 41 may give a warning through the warning device 17 (a step S20).

Furthermore, the control section 41 performs processing of acquiring a facial image (the second facial image) through the interface 45 as biometric information (the second biometric information) of the passenger M2 shot by the camera 15 (a step S14). When it is determined that the boarding ticket information read by the boarding ticket information acquiring section 44 is valid (the step S13, YES) and the facial image of the passenger shot by the camera 15 can be acquired, the control section 41 transmits the boarding ticket information read by the boarding ticket information acquiring section 44 and the second facial image of the passenger M2 shot by the camera 15 to the matching device 16 (a step S15).

The gate device 14 which has transmitted the boarding ticket information and the second facial image to the matching device 16 waits for a result of matching of the second facial image (the facial image when approaching the boarding gate) and the first facial image (the facial image at the time of the boarding procedure) recorded in the ticketing information managing device 13 in accordance with the boarding ticket information by the matching device 16. It is to be noted that face matching processing by the matching device 16 will be described later in detail.

When a result of collating the first facial image with the second facial image is received from the matching device 16 (a step S16), the control section 41 judges whether the result of collating the first facial image with the second facial image corresponds to the same person (a step S17). That is, when the matching device 16 determines that the first facial image and the second facial image correspond to the same person, the control section 41 determines that a person which has been subjected to the boarding procedure does not substitute for a person who passes through the boarding gate. On the contrary, when the matching device 16 determines that the first facial image and the second facial image do not correspond to the same person, the control section 41 determines that a person who has been subjected to the boarding procedure substitutes for a person who passes through the boarding gate.

When it is determined that there is no substitution by the judgment (the step S17, YES), the control section 41 opens the gate G through the gate control section 46 (a step S18), and allows the passenger M2 to pass through the boarding gate. Furthermore, when it is determined that there is substitution by the judgment (the step S17, NO), the control section 41 closes the gate G by using the gate control section 46 (a step S19) to inhibit passage of the passenger M2 through the boarding gate. Moreover, when it is determined that there is substitution by the judgment (the step S17, NO), the control section 41 informs the warning device 17 that passage of the passenger M2 is inhibited and there is a possibility of substitution of the passenger M2 (a step S20). Upon receiving such information, the warning device 17 gives a warning through the warning unit 74 or displays a message indicating that passenger is inhibited from passing through the gate in the display section 72.

It is to be noted that the warning device 17 may give a warning based on information such as a result of the matching supplied from the matching device 16. In this case, the warning device 17 displays a result of the matching fed from the matching device 16 and information or the like concerning the passenger in the display section 72. Here, the warning device 17 gives a warning by using the warning unit 74 based on the information indicating that passage of the passenger is inhibited from the gate device 14, and displays a result of the matching supplied from the matching device 16 and information or the like concerning the passenger in the display section 72.

Face matching processing by the matching device 16 will now be described.

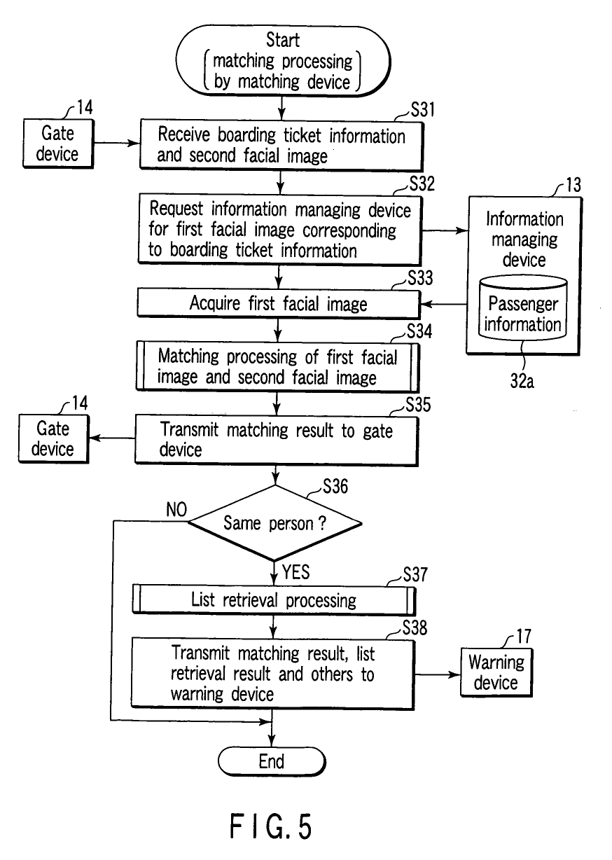

FIG. 5 is a flowchart illustrating the face matching processing by the matching device 16.

As described above, the gate device 14 transmits the facial image (the second facial image) of the passenger M2 who has approached the gate shot by the camera 15 and the boarding ticket information owned by the passenger M2 to the matching device 16. On the other hand, the matching device 16 collates the second facial image with the first facial image corresponding to the boarding ticket information.

That is, when the second facial image and the boarding ticket information from the gate device 14 are received through the interface 62 (a step S31), the control section 61 of the matching device 16 requests the ticketing information managing device 13 to transmit the first facial image corresponding to the boarding ticket information (a step S32). The ticketing information managing device 13 stores the passenger information including the boarding ticket information issued in the boarding procedure and the facial image (the first facial image) of the passenger who has been subjected to the boarding procedure in the database 32a. The control section 31 of the ticketing information managing device 13 which has received a request of the first facial image with respect to the boarding ticket information from the matching device 16 through the interface 33 retrieves the first facial image corresponding to the boarding ticket information from the database 32a. When the first facial image corresponding to the boarding ticket information is extracted as a result of this retrieval, the control section 31 transmits the extracted first facial image to the matching device 16 through the interface 33.

When the first facial image corresponding to the boarding ticket information fed from the ticketing information managing device 13 is received (a step S33), the control section 61 of the matching device 16 performs the face matching processing of collating the first facial image acquired from the ticketing information managing device 13 with the second facial image received from the gate device 14 together with the boarding ticket information by using the face matching section 63 (a step S34). This face matching processing is processing of judging whether the first facial image and the second facial image are facial images of the same person.

For example, the face matching section 63 calculates a degree of similarity of the first facial image and the second facial image, and compares the calculated degree of similarity with a preset threshold value. When the calculated degree of similarity is not smaller than the threshold value as a result of this comparison, the face matching section 63 determines that the first facial image and the second facial image correspond to the same person (may correspond to the same person). When the calculated degree of similarity is smaller than the threshold value, the face matching section 63 determines that the first facial image and the second facial image do not correspond to the same person (may not correspond to the same person).

That is, as a result of the above-described face matching processing, whether the first facial image and the second facial image correspond to the same person can be determined. When a result of the face matching processing is obtained, the control section 61 of the matching device 16 transmits the result of the face matching processing (or an instruction to open/close the gate in accordance with the result of the face matching processing) to the gate device 14 (a step S35).

It is to be noted that whether the first facial image and the second facial image represents whether a person who has been subjected to the boarding procedure substitutes for a person which has approached the boarding gate. That is, when it is determined that the first facial image and the second facial image correspond to the same person, it can be decided that a person who has been subjected to the boarding procedure do not substitute for a person who has approached the boarding gate. On the contrary, when it is determined that the first facial image and the second facial image do not correspond to the same person, it can be decided that a person who has been subjected to the boarding procedure substitutes for a person who has approached the boarding gate.

When it is determined that the first facial image and the second facial image do not correspond to the same person by the face matching processing (a step S36, NO), the control section 61 of the matching device 18 executes list retrieval processing of retrieving a facial image which matches with the second facial image from the list data 64a (a step S37). In this list retrieval processing, degrees of similarity of the second facial image and facial images of all specific persons registered in the list data 64a are calculated, and a predetermined number of facial images aligned in descending order of the degrees of similarity with respect to the second facial image are determined as a result of the retrieval.

It is to be noted that the list retrieval processing may judge whether a maximum one of degrees of similarity of the second facial images and respective facial images in the list data 64a is not smaller than the predetermined threshold value. In this case, if there is a facial image whose degree of similarity is not smaller than the predetermined threshold value in the list retrieval processing, a result of the list retrieval processing that a person having the second facial image may be a person having the facial image whose degree of similarity is not smaller than the predetermined threshold value is obtained. If there is no facial image whose degree of similarity is not smaller than the predetermined threshold value, a result of the list retrieval processing that a person who may be the person having the second facial image is not registered in the list can be obtained.

When the list retrieval processing is performed, i.e., when it is determined that the first facial image and the second facial image do not correspond to the same person by the face matching processing, the control section 61 of the matching device 16 transmits information such as a matching result of the facial image in the boarding procedure (the first facial image) and the facial image when approaching the boarding gate (the second facial image), a result of the list retrieval processing and others as information concerning the passenger (the passenger who is inhibited from passing through the gate G by the gate device 14) to the warning device 17 (a step S38). Upon receiving such information, the warning device 17 displays in the display section 43 the facial image in the boarding procedure (the first facial image), the facial image when approaching the boarding gate (the second facial image), the matching result, the result of the list retrieval processing and others.

It is to be noted that, when it is determined that the first facial image and the second facial image correspond to the same person by the face matching processing, the control section 61 of the matching device 16 may likewise transmit information such as a facial image in the boarding procedure (the first facial image), a facial image when approaching the boarding gate (the second facial image), a matching result and others to the warning device 17 as information concerning the passenger (the passenger who is allowed to pass through the gate G by the gate device 14). In this case, the warning device 17 can display in the display section 43 the facial image in the boarding procedure (the first facial image), the facial image when approaching the boarding gate (the second facial image), the matching result and others as information concerning the passenger who is allowed to pass through the gate G.

The list retrieval processing will now be described.

The list retrieval processing at the step S3 is processing executed in the boarding procedure, and it is a processing of retrieving a facial image which is similar to (or matches with) a facial image shot by the camera 12 (the first facial image) from facial images registered in the list data 64a. Further, the list retrieval processing at the step S37 is processing executed when approaching the boarding gate (when approaching the gate G), and it is processing of retrieving a facial image which is similar to (or matches with) a facial image shot by the camera 15 (the second facial image) from facial images registered in the list data 64a.

Here, it is assumed that the list retrieval processing at the steps S3 and S37 is executed by the matching device 16. It is to be noted that the list retrieval processing at the step S3 may be executed in the ticketing device 11 by providing a face matching section and a data memory which stores list data in the ticketing device 11. The list retrieval processing at the steps S3 or S37 may be executed in the ticketing information managing device 13, the gate device 14 or the warning device 17 by providing a face matching section and a data memory which stores list data in the ticketing information managing device 13, the gate device 14 or the warning device 17.

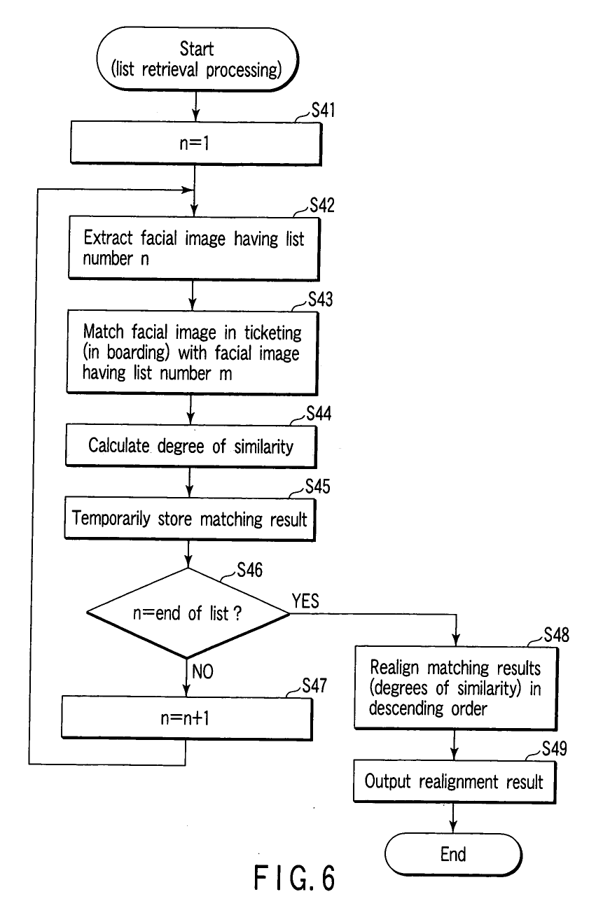

FIG. 6 is a flowchart illustrating the list retrieval processing.

That is, when the first facial image (or the second facial image) which should be subjected to the list retrieval processing is given, the control section 61 of the matching device 16 initializes a variable n which is stored in a non-illustrated memory in the control section 61 (a step S41). Here, it is assumed that an initial value of n is “1” (n=1). Furthermore, a facial image of each specific person is associated with each list number in the list data 64a.

First, when the variable n is initialized, the control section 61 extracts a facial image having a list number n (“n=1”) in the list data 64a (a step S42). When the facial image having the list number n is extracted from the list data 64a, the control section 61 allows the face matching section 63 to perform matching processing of the first facial image (or the second facial image) of the passenger M2 acquired in the boarding procedure (or when approaching the boarding gate) and the facial image having the list number n (a step S43). As a result, the face matching section 63 calculates a degree of similarity as a result of collating the first facial image (or the second facial image) with the facial image having the list number n (a step S44). The degree of similarity as a result of matching is supplied to the control section 61, associated with the facial image having the list number n and stored in a non-illustrated memory or the like in the control section 61 (a step S45).

Then, the control section 61 judges whether the current variable n is the last list number in the list data 64a (a step S46). That is, here, the control section 61 judges whether the matching processing (calculation processing of degrees of similarity) of all face images in the list data is completed. When it is determined that the current variable n is not the last list number by the above-described judgment (the step S46, NO), the control section 61 increments the variable n (n=n+1) (a step S47) and returns to the step S42. Therefore, the processing at the steps S41 to S47 is repeatedly executed until the variable n becomes the last list number (i.e., until the matching processing with respect to all facial images in the list data 64a is completed).

Furthermore, when it is determined that the variable n is the last list number at the step S46 (the step S46, YES), the control section 61 rearranges degrees of similarity as respective matching results stored in a non-illustrated memory in descending order (a step S48). That is, facial images registered in the list data 64a are arranged in descending order of degrees of similarity with respect to the first facial image (or the second facial image). Such facial images arranged in descending order of the degrees of similarity are output to the ticketing device 11 (or the warning device 17) as a result of the list retrieval processing (a step S49).

According to such list retrieval processing, the ticketing device 11 (or the warning device 17) can display in the display section 23 (or the display section 72) facial images registered in the list data 64a arranged in descending order of the degrees of similarity with respect to the first facial image (or the second facial image). Moreover, when an attendant visually recognizes such matching results obtained by the list retrieval processing, an appropriate procedure according to the matching results can be performed by the attendance in this system. For example, it is possible to strengthen surveillance on a marked person registered in a black list, take a specific person such as a wanted person registered in a black list into custody, or provide a special service to a specific person such as an important customer registered in a white list.

It is to be noted that the first facial image shot by the camera 12 in the boarding procedure (ticketing) or the second facial image shot by the camera 15 at the time of boarding (approaching the gate) may be held as history information in a storage device, e.g., the ticketing information managing device 13 in this admittance management system. As a result, when, e.g., an incident or an accident occurs, the admittance management system can perform after-the-fact confirmation of a facial image in the ticketing procedure or a facial image at the time of boarding.

In the admittance management system according to the first embodiment, a facial image of a person who has been subjected to the boarding procedure is stored in association with boarding ticket information, a judgment is made upon whether the facial image of the person who has been subjected to the boarding procedure and a facial image of a person who has approached the boarding gate correspond to the same person, and the gate G at the boarding gate is controlled to be opened/closed or the warning device 17 gives a warning based on a result of this judgment.

As a result, it is possible to judge whether the person who has been subjected to the boarding procedure is the same as the person who has approached the boarding gate, thereby preventing the person who has finished the boarding procedure from substituting for the person who has approached the boarding gate.

A second embodiment will now be described.

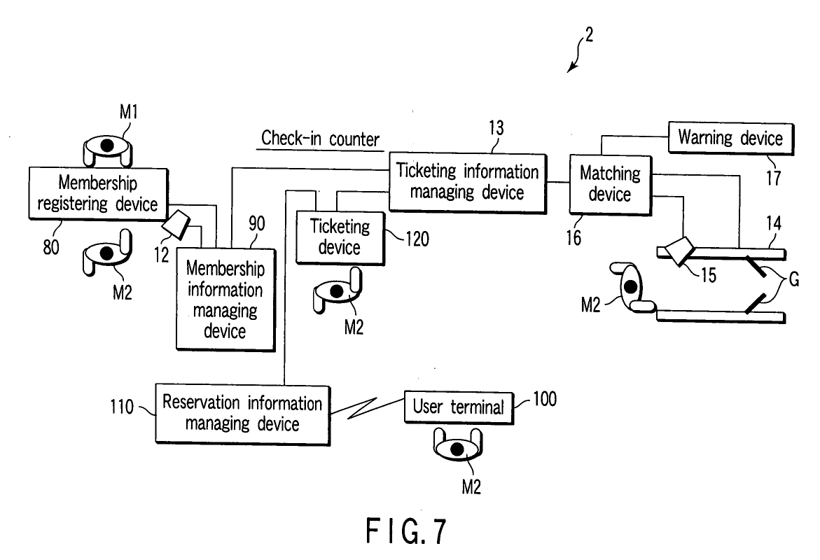

FIG. 7 schematically shows an entire configuration of an admittance management system 2 according to a second embodiment. The admittance management system 2 depicted in FIG. 7 is constituted of a camera 12, a ticking information managing device 13, a gate device (a passage control device) 14, a camera 15, a matching device 16, a warning device 17, a membership registering device 80, a membership information managing device 90, a user terminal 100, a reservation information managing device 110, a ticketing device (a boarding procedure device) 120 and others. It is to be noted that, as the admittance management system 2 according to the second embodiment, one which manages admittance (boarding) to a passenger plane as a security area is assumed like the admittance management system 1 of the first embodiment. In other words, the admittance management system 2 which will be described in the second embodiment is a modification of the admittance management system 1 explained in the second embodiment.

The admittance management system 2 according to the second embodiment is a system which realizes a reservation by a specific person (a member), a ticketing procedure based on reservation information and others in addition to the admittance management system 1 according to the first embodiment. As a result, in the admittance management system 2, a ticketless reservation by a member can be made, thereby simplifying the ticketing procedure.

It is to be noted that, in the admittance management system 2 according to the second embodiment shown in FIG. 7, like reference numerals denote devices having the same configurations as those in the admittance management system 1 in the first embodiment depicted in FIG. 1, thereby admitting the detailed explanation.

The membership registering device 80 is a device which performs membership registration procedure. The membership registering device 80 is installed at, e.g., a membership registration reception counter in an airport (or outside an airport in some cases). The membership registering device 80 performs the membership registration procedure by an operation by an attendant (a staff of an airline company) M1. Further, the membership registering device 80 issues a membership card with respect to a person who has completed the membership registration procedure.

In the admittance management system 2, the camera (a first facial image acquiring device) 12 is set in the vicinity of the membership registering device 80. The camera 12 acquires a first facial image of a person (a passenger) M2 subjected to the membership registration procedure as first biometric information. The camera 12 is mainly formed of, e.g., a video camera.

The membership information managing device 90 is a device which stores information concerning a member (registration information). The registration information stored in the membership information managing device 90 includes, a facial image (a first facial image) of the person (a member) M2 acquired by the camera 12 in at least the membership registration procedure. Furthermore, as registration information other than the first facial image, there are, e.g., a name, an address, an age, a gender, a telephone number and others of the member.

The user terminal 100 is a terminal device used by each member. For example, as the user terminal 100, a portable terminal device such as a personal computer or a mobile phone is used. Moreover, the user terminal 100 has a communicating function with respect to the reservation information managing device 110. The user terminal 100 makes a flight reservation for a passenger plane by communicating with the reservation information managing device 110. For example, a flight reservation is made by the user terminal 100, reservation information of the member (the passenger) M2 is stored in the reservation information managing device 110.

The ticketing device 120 is a device which performs a boarding procedure of each person (each passenger) M2 who gets on board a passenger plane. Additionally, the ticketing device 120 is a device which executes processing of issuing a boarding ticket (an admission ticket) or recording boarding ticket information in the user terminal 100 as the boarding procedure with respect to a person who gets on board (gets admittance to) a passenger plane (a security area). That is, the ticketing device 120 issues boarding ticket information in accordance with each person (each passenger) M2 who has completed the boarding procedure for the passenger plane, and registers the boarding ticket information in the ticketing information managing device 13. The ticketing device 120 may perform the boarding procedure by an operation by a passenger himself/herself or by an operation by an attendant.

Here, it is assumed that the ticketing device 120 executes the boarding procedure by an operation by a member himself/herself based on reservation information. Further, it is assumed that the ticketing device 120 records the boarding ticket information in an electronic device such as a mobile phone or an IC card owned by a user as the user terminal 100 as the boarding ticket issuing processing. In this case, the user terminal 100 in which the boarding ticket information is recorded is utilized as a boarding ticket. It is to be noted that the ticketing device 120 may be configured to issue as a boarding ticket a recording medium in which boarding ticket information such as a ticket number of the boarding ticket, a name of a passenger, a flight number of a passenger plane, a seat number and others is recorded.

Furthermore, the ticketing information managing device 13 acquires the boarding ticket information fed from the ticketing device 120 and the first facial image shot in the membership registration procedure of the member from the membership information managing device 90, and stores them together with ticketing information of the passenger M2.

A description will now be given as to a structural example of each device constituting the admittance management system 2.

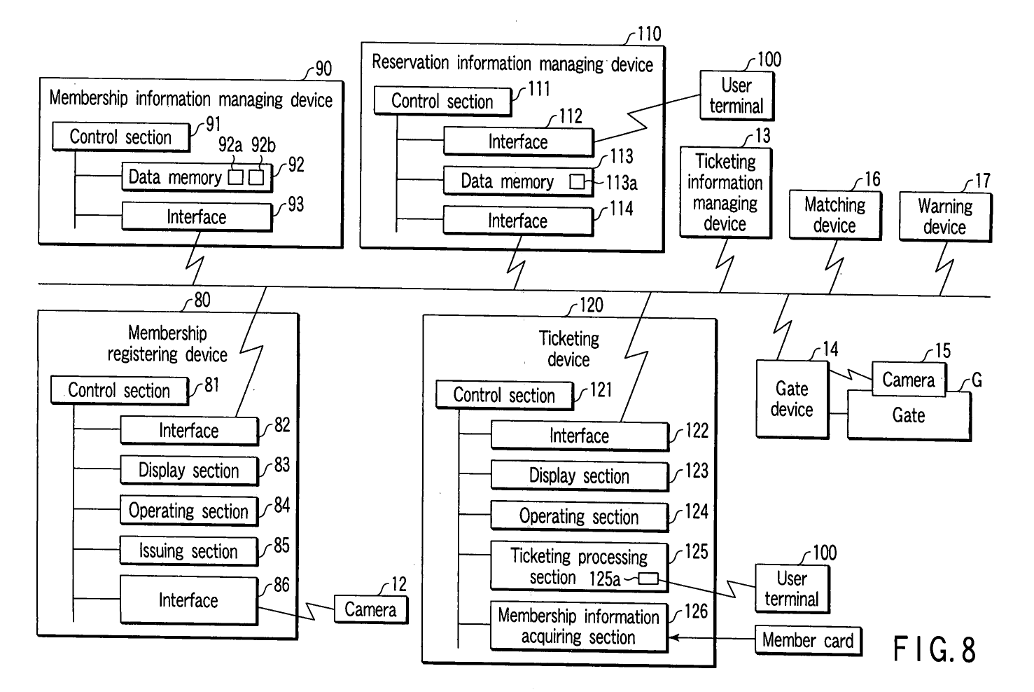

FIG. 8 is a block diagram schematically showing a structural example of each device constituting the admittance management system 2. As shown in FIG. 8, in the admittance management system 2, the ticketing information managing device 13, the gate device 14, the matching device 16, the warning device 17, the membership registering device 80, the membership information managing device 90, the reservation information managing device 110, the ticketing device 120 and others are connected with each other through a network 18. Further, the camera 12 is connected with the ticketing device 11. The camera 15 is connected with the gate device 14 (or the matching device 16). The user terminal 100 has a function of communicating with the reservation information managing device 110 or the ticketing device 120.

A structural example of the membership registering device 80 will be first explained.

As shown in FIG. 2, the membership registering device (the membership registration procedure device) 80 has a control section 81, an interface 82, a display section 83, an operating section 84, a membership card issuing section 85, an interface 86 and others.

The control section 81 controls the entire membership registering device 80. The control section 81 is constituted of a CPU as an arithmetic operating section, an ROM and an ROM as memories, various kinds of interfaces which connect respective portions in the device and others. The control section 81 is configured to realize various kinds of processing by executing a control program or the like stored in memories.

The interface 82 is an interface which performs data communication with each device through the network 18. That is, the interface 82 functions as a communicating section which executes data communication with each device.

The display section 83 is a device which displays guidance or the like for the boarding procedure. The operating section 84 is a device to which information is input by an attendant or a user. The operating section 84 is constituted of various kinds of operation keys or the like. For example, the display section 83 and the operating section 84 are formed of, e.g., a liquid crystal display device having a built-in touch panel.

The membership card issuing section 85 performs processing of issuing a membership card. For example, in case of issuing a boarding ticket in which boarding ticket information is recorded in a recording medium having a magnetic or IC recording portion, the membership card issuing section 85 carries out processing of recording membership information or the like including a member ID in the recording portion of the recording medium having the magnetic or IC recording portion or of printing membership information on a surface of the recording medium.

Additionally, in an operational conformation where membership information is recorded in an electronic device owned by a user as the user terminal 100 without issuing a membership card, the membership card issuing section 85 is configured to perform processing of recording the membership information in the user terminal 100 owned by the user. In this case, the membership card issuing section 85 is provided with a communication module which carries out communication with the user terminal 100.

The interface 86 is an interface which acquires a facial image (the first facial image) as biometric information (first biometric information) of a person who is taking the membership registration procedure. In the structural example shown in FIG. 7 or 8, the interface 86 is connected with the camera 12, and functions as an image input interface which acquires a facial image (the first facial image) of a person taking the membership registration procedure shot by the camera 12.

A structural example of the membership information managing device 90 will now be described.

The membership information managing device 90 has a control section 91, a data memory 92, an interface 93 and others as shown in FIG. 8.

The control section 91 controls the entire membership information managing device 90. The control section 91 is constituted of a CPU as an arithmetic operating section, an RAM and an ROM as memories, various kinds of interfaces which connect respective sections in the device, and others. The control section 91 is configured to realize various kinds of processing by executing a control program or the like stored in memories. For example, the control section 91 has a function of retrieving information stored in the data memory 92 based on information which serves as a retrieval key. Furthermore, the control section 91 also has a function of retrieving a first facial image corresponding to membership information in response to a first facial image retrieval request based on the membership information such as a member ID or the like from the ticketing information managing device 13 or the reservation information managing device 110, and returning the first facial image as a result of this retrieval to the ticketing information managing device 13 or the reservation information managing device 10.

The data memory 92 is formed of a high-capacity storage device such as a hard disk drive. The data memory 92 has a database 92a which stores membership information or the like including the first facial image of the member in the admittance management system. As a result, the membership information stored in the database 92a can be retrieved based on information such as a member ID.

Additionally, the data memory 92 stores list data 92b consisting of information including at least a facial image concerning a specific person. The list data 92b is data stored in the data memory 32 in advance. The list data 92b is used as a black list or a white list in the admittance management system like the list data 32b, and information including at least a facial image of a specific person is configured in the form of a list.

The interface 93 is an interface which performs data communication with each device through the network 18. That is, the interface 93 functions as a communicating section which carries out data communication with each device.

A structural example of the reservation information managing device 110 will now be described.

As shown in FIG. 8, the reservation information managing device 110 has a control section 111, an interface 112, a data memory 113, an interface 114 and others.

The control section 111 controls the entire reservation information managing device 110. The control section 111 is constituted of a CPU as an arithmetic operating section, an RAM and an ROM as memories, various kinds of interfaces which connect respective sections in the device, and others. The control section 111 is configured to realize various kinds of processing by executing a control program or the like stored in memories. For example, the control section 111 has a function of retrieving information stored in the data memory 113 based on information serving as a retrieval key. Further, the control section 111 also has a function of retrieving reservation information corresponding to membership information in response to a reservation information retrieval request based on the membership information such as a member ID from the ticketing device 120, and returning the reservation information as a result of this retrieval to the ticketing device 120.

The interface 112 is an interface which performs data communication with the user terminal 100. The interface 112 may be a communicating section which carries out data communication with the user terminal 100 through wireless communication, or may be a communicating section which performs data communication with the user terminal 100 through a network line such as Internet.

The data memory 113 is formed of a high-capacity storage device such as a hard disk drive. The data memory 113 manages information concerning a flight reservation for a passenger plane by a member. The data memory 113 has a database 113a which stores reservation information in the admittance management system 2. The database 113a stores reservation information having membership information and information concerning a reserved passenger plane or the like. As a result, the reservation information stored in the database 113a can be retrieved based on the membership information and others.

The interface 114 is an interface which carries out data communication with respective devices through the network 18. That is, the interface 114 functions as a communicating section which carries out data communication with each device.

A structural example of the ticketing device 120 will be first described.

As shown in FIG. 8, the ticketing device (the boarding procedure device) 120 has a control section 121, an interface 122, a display section 123, an operating section 124, a ticketing processing section 125, a membership information acquiring section 126 and others.

The control section 121 controls the entire ticketing device 120. The control section 121 is constituted of a CPU as an arithmetic operating section, an RAM and an ROM as memories, various kinds of interfaces which connect respective sections in the device, and others. The control section 121 is configured to realize various kinds of processing by executing a control program or the like stored in memories.

The interface 122 is an interface which performs data communication with each device through the network 18.

The display section 123 is a device which displays guidance or the like for the boarding procedure. The operating section 124 is a device to which information is input by a user or an attendant. The operating section 124 is constituted of various kinds of operation keys or the like. For example, the display section 123 and the operating section 124 are formed of a liquid crystal display device or the like having a built-in touch panel.

The ticketing processing section 125 carries out ticketing processing of a boarding ticket. For example, in case of issuing a boarding ticket in which boarding ticket information is recorded in a recording medium having, e.g., a magnetic or IC recording portion, the ticketing processing section 125 performs processing of recording boarding ticket information in the recording portion of the recording medium or printing the boarding ticket information on a surface of the recording medium.

Further, in an operational conformation where boarding ticket information is recorded in an electronic device as the user terminal 100 owned by a user, the ticketing processing section 125 is configured to perform processing of recording the boarding ticket information in the user terminal 100 as ticketing processing of a boarding ticket. In this case, the ticketing processing section 125 is provided with an interface 125a which carries out data communication with an electronic device as the user terminal 100 owned by a user. For example, when the user terminal 100 has a non-contact type wireless communicating function, the interface 125a is provided with a reader/writer device corresponding to the communication mode.

The membership information acquiring section 126 acquires membership information from a membership card owned by a user (or a user terminal owned by a user). For example, when the membership card is a recording medium having a magnetic recording portion or an IC memory, the membership information acquiring section 126 is formed of a device which reads membership information from the recording medium as the membership card. Furthermore, in an operational conformation where membership information is recorded in the user terminal 100 owned by a user in place of the membership card, the membership information acquiring section 126 is constituted of an interface or the like which performs data communication with the user terminal 100. In this case, the interface 125a may be used as the membership information acquiring section 126. Moreover, an image input interface which acquires a facial image from the camera which takes a facial image of a person who is taking the boarding procedure may be provided in the ticketing device 120 like the first embodiment.

It is to be noted that structures of the ticketing information managing device 13, the gate device 14, the matching device 16, the warning device 17 and others are the same as those in the admittance management system 1 according to the first embodiment shown in FIGS. 1 and 2, thereby omitting the detailed explanation.

Additionally, a hardware configuration of the admittance management system 2 can be modified in many ways corresponding to operational conformations and others. For example, the ticketing information managing device 13, the membership information managing device 90, the reservation information managing device 110 and others may be configured as a single integrated server device.

Processing in each device constituting the admittance management system 2 will now be described.

Membership registration procedure processing by the membership registering device (the membership registration procedure device) 80 will be first explained.

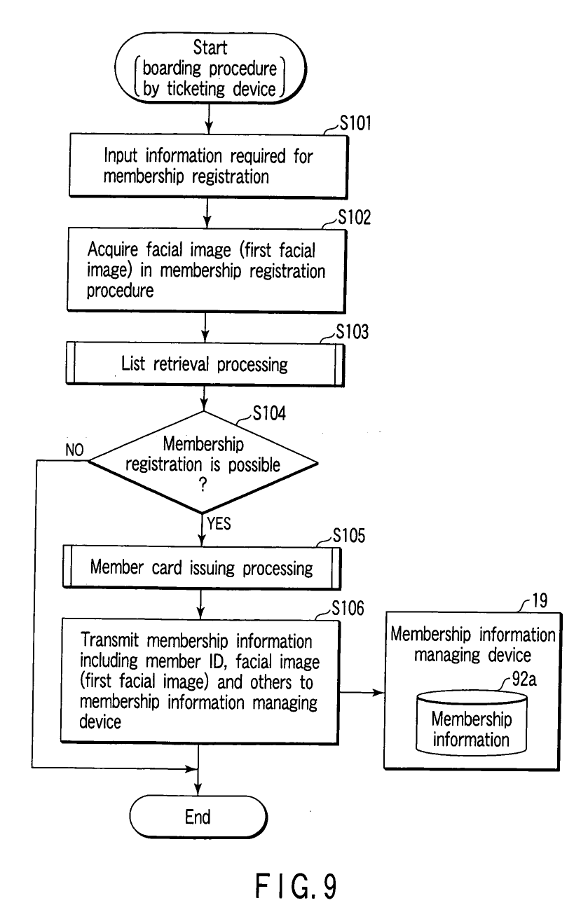

FIG. 9 is a flowchart illustrating the membership registration procedure processing by the membership registering device 80.

A person who wants to be registered as a member takes the membership registration procedure by the membership registering device 80. Here, a description will be given on the assumption that the membership registration procedure is performed by the membership registering device 80 which is installed in, e.g., a membership registration counter and operated by an attendant.

First, a person M2 which has visited the membership registration counter informs an attendant of information required for the membership registration procedure. Then, the attendant M1 examines whether the person M2 is a person who satisfies conditions for the membership registration.

When it is determined that this person is a person who can be registered as a member, the attendant M1 sequentially inputs information required for the membership registration procedure by using the operating section 84 in the membership registering device 80 (a step S101). Further, when the information required for the membership registration procedure is being input or when input of the information required for the membership registration procedure is completed, the camera 12 takes a facial image (the first facial image) of the person M2. The membership registering device 80 acquires the first facial image taken by the camera 12 through the interface 86 (a step S102).

Upon acquiring the first facial image through the interface 86, the control section 81 in the membership registering device 80 requests the matching device 16 for list retrieval processing using the acquired first facial image (a step S103). In this case, the control section 81 of the membership registering device 80 transmits the request for the list retrieval processing using the first facial image together with the first facial image to the matching device 16, and receives a result of the list retrieval processing from the matching device 16.

It is to be noted that, as described in the first embodiment with reference to FIG. 6, the list retrieval processing by the matching device 16 is processing of calculating degrees of similarity of the first facial image and facial images of all specific persons registered in the list data 64a and determining a predetermined number of facial images aligned in descending order of the degrees of similarity with respect to the first facial image as a result of the retrieval. Further, the list retrieval processing may judge whether a maximum one of degrees of similarity of the first facial image and the respective facial images in the list data 64a is not smaller than a predetermined threshold value. In this case, which person registered in the list data 64a is the person having the first facial image is determined.

Furthermore, the list retrieval processing using the first facial image may be executed by the membership registering device 80 by providing a face matching section in the membership registering device 80. In this case, the list data 64a may be stored in a non-illustrated memory of the membership registering device 80 in advance.

The control section 81 of the membership registering device 80 judges whether conditions for allowing registration as a member are satisfied based on the information input by the operating section 84, the first facial image acquired through the interface 86, a result of the list retrieval processing or the like (a step S104). For example, when the information required for the membership registration procedure is all input by the operating section 84 and it is determined that the facial image (the first facial image) of the person does not belong to a person who is not allowed to be registered as a member in the list retrieval processing by the interface 86, the control section 81 determines to permit registration of this person as a member.

When it is determined that registration of this person as a member is permitted by the above-described judgment (the step S104, YES), the control section 81 issues a member number (a member ID) through the membership card issuing section 85 and performs membership card issuing processing with respect to the corresponding person (a step S105). In this membership card issuing processing, a recording medium in which information such as a member ID is recorded is issued as a membership card. Further, in an operational conformation where information such as a member ID is recorded in the user terminal 100 owned by a user in place of the membership card, it is good enough to record information such as a member ID in the user terminal 100 owned by the user as the membership card issuing processing.

When the membership card is issued by the membership card issuing processing, the control section 81 transmits information such as a corresponding member ID and a name, an address, a gender, a phone number and others of the corresponding person as well as a facial image (the first facial image) taken by the camera 12 to the membership information managing device 90 as membership information (a step S106). The membership information managing device 90 which has received this membership information records this membership information in the database 92a. Furthermore, the member card issued by the ticking processing is handed to the corresponding person from an attendant. According to the above-described processing, the membership registration procedure with respect to the person M2 is brought to completion.

A description will now be given as to flight reservation processing for a passenger plane by the reservation information managing device 110 using the user terminal 100.

A person (a member) who has finished the above-described membership registration procedure can make a flight reservation for a desired passenger plane by using the user terminal 100. In the flight reservation processing, a user who has finished the membership registration requests a flight reservation for a specific passenger plane by using the user terminal 100. In response to this, the reservation information managing device 110 makes a flight reservation for this member. Moreover, upon completion of the flight reservation, the reservation information managing device 110 stores information concerning this reservation (reservation information) in the data memory 113.

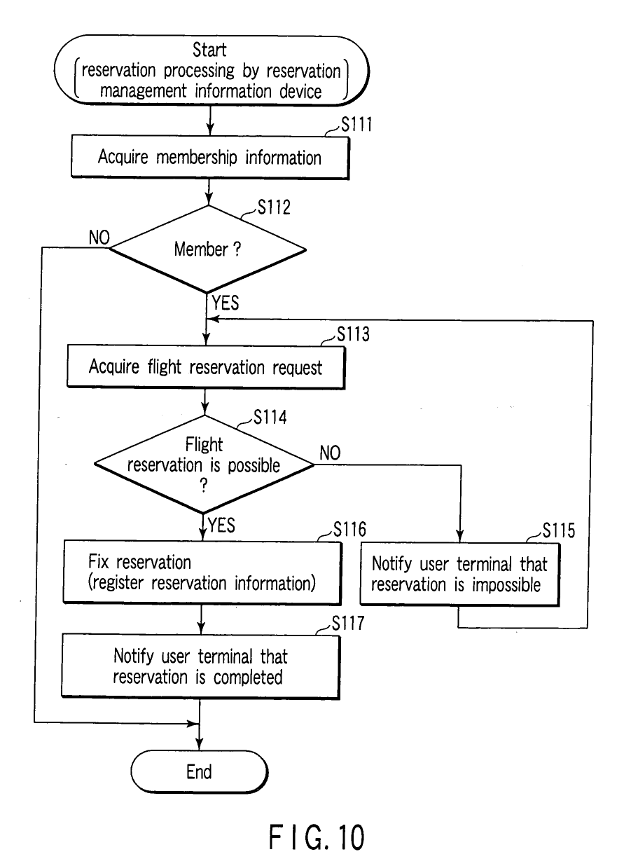

FIG. 10 is a flowchart illustrating an example of the flight reservation processing by the reservation information managing device 110 utilizing the user terminal 100.

First, a user who has been registered as a member requests access by utilizing the user terminal 100, and transmits information such as a member ID to the reservation information managing device 110. At this time, the user terminal 100 and the reservation information managing device 110 may perform user authentication by using a password or the like. The reservation information managing device 110 receives the information transmitted from the user terminal 100 through the interface 112 (a step Sill). Upon receiving the information such as a member ID through the interface 112, the control section 111 of the reservation information managing device 110 confirms whether the user is a member (a step S112). For example, the control section 111 of the reservation information managing device 110 inquires of the membership information managing device 90 whether the information received from the user terminal 100 concerns a registered member, and confirms whether this user is a member based on a result of this inquiry.

When it is confirmed that this user is a member, the control section 111 of the reservation information managing device 110 requests the user terminal 100 for information about a flight number of a passenger plane to be reserved. In response to this, the user terminal 100 specifies a flight number or the like of a passenger plane to be reserved by the user. The information such as a reservation target flight number specified by the user is transmitted from the user terminal 100 to the reservation information managing device 110. Upon receiving the information such as a flight number of a the passenger plane to be reserved (a step S113), the control section 111 of the reservation information managing device 110 judges whether a flight reservation of this passenger plane can be made based on a reservation status or the like of the passenger plane having this flight number (a step S114). For example, the control section 111 of the reservation information managing device 110 judges an unoccupied seat status of this passenger plane from the reservation information stored in the database 113a, and judges whether a flight reservation can be made in accordance with the unoccupied seat status of the passenger plane.

When it is determined that the flight reservation cannot be made based on the judgment (the step S114, NO), the control section 111 of the reservation information managing device 110 notifies the user terminal 100 of a fact that the flight reservation of the specified passenger plane cannot be made (a step S115).

Moreover, when it is determined that the flight reservation can be made by the judgment (the step S114, YES), the control section 111 of the reservation information managing device 110 fixes the flight reservation of the specified passenger plane, and executes processing of storing the reservation information in the database 113a (a step S116). In this case, the database 113a stores a fight number associated with information such as a member ID as the reservation information. When the reservation information is stored in the database 113a, the control section 111 of the reservation information managing device 110 notifies the user terminal 100 of completion of making the flight reservation of the specified passenger plane (a step S117).

The boarding procedure processing by the ticketing device (the boarding procedure device) 120 will now be described.

A member who has made the above-described flight reservation brings the member card or the user terminal 100 in which the membership information is recorded to carry out the boarding procedure through the ticketing device 120. A description will be given as to the boarding procedure processing with respect to a member in particular. It is to be noted that the boarding procedure with respect to a person (a passenger) who has not made a flight reservation or a person who has not been registered as a member can be realized by the same procedure as the processing described in the first embodiment with reference to FIG. 3.

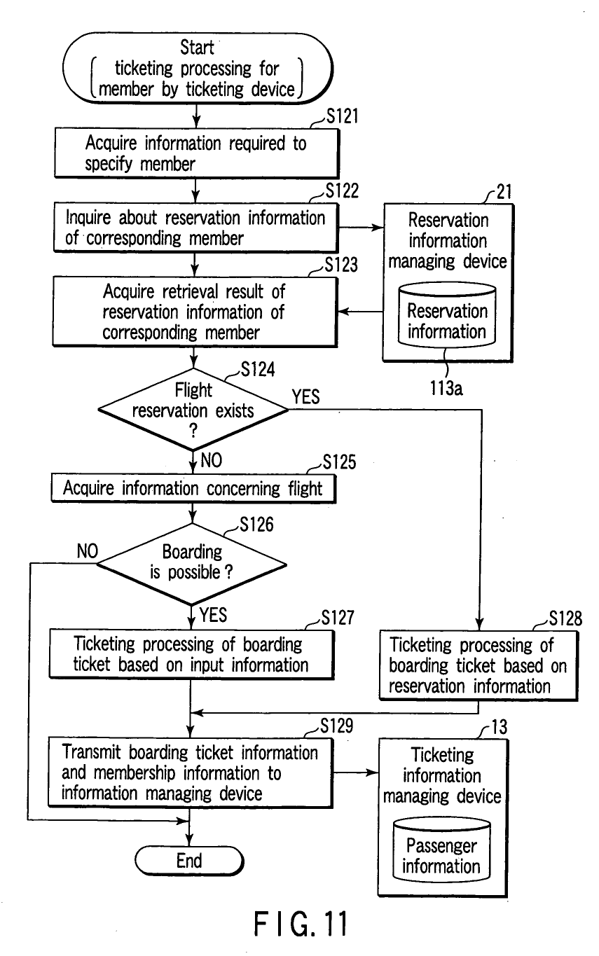

FIG. 11 is a flowchart illustrating the boarding procedure processing with respect to a member by the ticketing device 120.

A member (a passenger) who has made a flight reservation for a passenger plane first performs an operation of inputting information such as a member ID to the ticketing device 120. For example, in case of inputting information such as a member ID by using a member card issued in the membership registration, the member allows the membership information acquiring section 126 of the ticketing device 120 to read information such as a member ID stored in the member card. As a result, the membership information acquiring section 126 acquires information such as a member ID from the member card presented by the member (a step S121). Additionally, in a case where information such as a member ID is recorded in the user terminal 100, the membership information acquiring section 126 acquires information such as a member ID from the user terminal 100 owned by the member.

Upon acquiring the information such as a member ID, the control section 121 of the ticketing device 120 inquires of the reservation information managing device 110 about reservation information of this member by using the information, e.g., a member ID as a retrieval key (a step S122). In response to such an inquiry, the reservation information managing device 110 retrieves the reservation information of this member from the database 113a, and returns a result of this retrieval to the ticketing device 120. It is to be noted that, when the reservation information of this member does not exist, the reservation information managing device 110 informs the ticketing device 120 of a fact that the reservation information of this member does not exist as a result of the retrieval.

Upon receiving the retrieval result from the reservation information managing device 110 in response to the inquiry (a step S123), the control section 121 of the ticketing device 120 judges whether the reservation information of this member exists based on the received retrieval result (a step S124).

When it is determined that the reservation information of this member does not exist by this judgment (the step S124, NO), the control section 121 of the ticketing device 120 accepts a specification of a passenger plane that this member wants to get on board (a flight) (a step S125). When the member specifies the flight by using the operating section 84, the control section 121 judges whether boarding the specified flight is possible (a step S126). When it is determined that boarding is possible by this judgment, the control section 121 performs ticketing processing for a boarding ticket required to get on board the flight specified by the member (a step S127).

Further, when it is determined that the reservation information of this member exist by the judgment (the steps S124, YES), the control section 121 of the ticketing device 120 acquires the reservation information of this member from the reservation information managing device 110 and performs ticketing processing for a boarding ticket based on this reservation information (a step S128).

In the ticketing processing for the boarding ticket, for example, the ticketing processing section 125 issues as the boarding ticket a recording medium in which boarding ticket information such as a name of a passenger, a flight number of a target passenger plane, a seat number and others is recorded. Furthermore, in an operational conformation where the user terminal 100 or a member card owned by a user can be utilized in place of a boarding ticket, the ticketing processing section 125 of the ticketing device 120 records boarding ticket information in the user terminal 100 or the member card owned by the user as the ticketing processing for the boarding ticket. The boarding ticket issued by the above-described ticketing processing is handed to the passenger.

Moreover, upon issuing the boarding ticket by the ticketing processing, the control section 121 of the ticketing device 120 acquires a facial image (the first facial image) of the member taken by the camera 12 at the time of membership registration from the membership information managing device 90. When the first facial image of the member is acquired from the membership information managing device 90, the control section 121 transmits as passenger information the information recorded on the boarding ticket (the boarding ticket information) and the first facial image acquired from the membership information managing device 90 to the ticketing information managing device 13 (a step S129).

The ticketing information managing device 13 which has received the passenger information from the ticketing device 120 records the passenger information in the database 32a. It is to be noted that the ticketing information managing device 13 may acquire the first facial image of the member from the membership information managing device 90 and store it together with the boarding ticket information in the database 32a.

According to the above-described processing, the boarding procedure with respect to the member is brought to completion.

Passage control processing by the gate device 14 will now be described.

A passenger who has finished the above-described boarding procedure waits in a waiting room until a time to get on board a passenger plane. When a boarding time of the passenger plane is reached, the passenger goes to a boarding gate of the passenger plane with his/her boarding ticket. At this time, the gate device 14 provided at the boarding gate of the passenger plane performs passage control processing based on boarding ticket information recorded on the boarding ticked brought by the passenger and a facial image (the second facial image) of the passenger.

The passage control processing by the gate device 14 in the admittance management system 2 is the same as the processing described in the first embodiment with reference to FIG. 5. Therefore, a detailed explanation will be omitted. However, in the admittance management system 2 according to the second embodiment, a first facial image of a member who has finished a boarding procedure based on reservation information is a facial image taken by the camera 12 at the time of a membership registration procedure. Therefore, in the admittance management system 2, at the steps S34, a facial image shot at the time of a membership registration procedure is determined as the first facial image, and a judgment is made upon whether a person of this first facial image is the same as that of the second facial image. Additionally, the list retrieval processing at the time of boarding at the step S37 is the same as the processing described in the first embodiment with reference to FIG. 6. Therefore, a detailed explanation will be omitted.

In the admittance management system 2 according to the second embodiment, a facial image of a person who has finished the membership registration procedure is stored as membership information, and a flight reservation using the membership information is accepted. Further, at the boarding gate, a judgment is made upon whether the facial image at the time of the membership registration procedure of a person who has finished the boarding procedure based on the accepted reservation information is the same as a facial image of a person who has approached the boarding gate, and the gate G at the boarding gate is controlled to be opened/closed or a warning is given by the warning device 17 based on a result of this judgment.

As a result, it is possible to make a judgment upon whether a person who has performed the boarding procedure is the same as a person who has approached the boarding gate, thereby preventing the person who has finished the boarding procedure from substituting for the person who has approached the boarding gate.

Furthermore, in the admittance management system 2, registering the membership information including the facial image in advance can simplify the ticketless flight reservation and the boarding procedure.

A third embodiment will now be described.

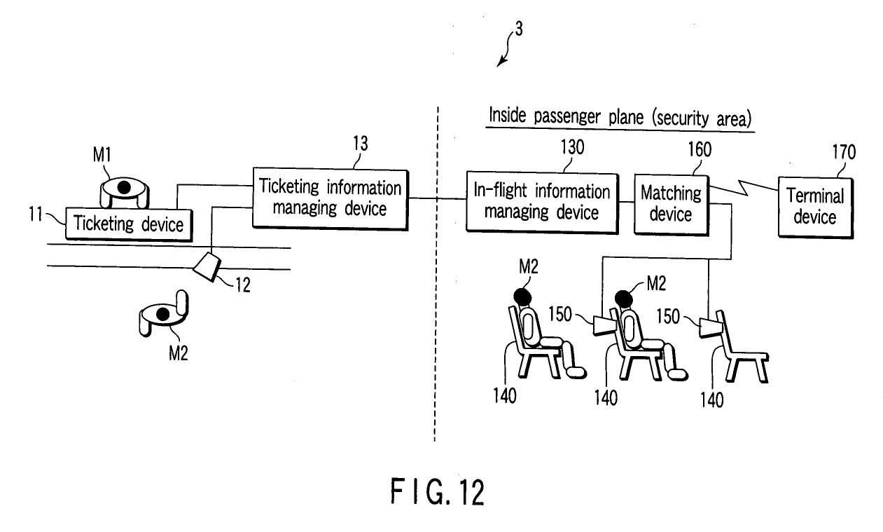

FIG. 12 schematically shows a structure of an admittance management system 3 according to the third embodiment.

The admittance management system 3 depicted in FIG. 12 is constituted of a camera 12, a ticketing device 11, a ticketing information managing device 13, an in-flight information managing device 130, a plurality of cameras 150, a matching device 160, a terminal device 170 and others. Incidentally, in the admittance management system 3 according to the third embodiment, it is assumed that the inside of a passenger plane is a security area and a person who has got on board the passenger plane is monitored. That is, the admittance management system 3 monitors whether a person who has taken each seat in the passenger planer is the same as a person who has performed a boarding procedure. Furthermore, in the admittance management system 3, processing concerning the boarding procedure is the same as that in the admittance management system 1 according to the first embodiment. Therefore, in the admittance management system 3 according to the third embodiment depicted in FIG. 12, like reference numerals denote devices having the same configurations as those in the admittance management system 1 according to the first embodiment shown in FIG. 1, thereby omitting a detailed explanation thereof.

As shown in FIG. 12, like the admittance management system 1 depicted in FIG. 1, the ticketing device 11 issues a boarding ticket of a passenger plane by an operation by an attendant M1 or a passenger himself/herself. The camera 12 as a first biometric information acquiring section is set in the vicinity of the ticketing device 11. The camera 12 takes a facial image (a first facial image) as biometric information of the person (the passenger) M2 who is taking a boarding procedure. The ticketing device 11 transmits issued boarding ticket information (information including at least a name of a passenger, a flight number of a passenger plane and a seat number) and the first facial image of the passenger M2 taken by the camera 12 as passenger information to the ticketing information managing device 13. Like the admittance management system 1 depicted in FIG. 1, the ticketing information managing device 13 stores the passenger information received from the ticketing device 11 in a database. Moreover, the ticketing information managing device 13 shown in FIG. 12 also has a function of performing data communication with the in-flight information managing device 130.

The in-flight information managing device 130, each camera 150, the matching device 160 and the terminal device 170 are set in the passenger plane. The in-flight information managing device 130, each camera 150 and the matching device 160 are connected with each other through a local area network. The local area network may be realized in the form of wire communication or wireless communication. Additionally, the terminal device 170 can perform data communication with at least the matching device 160 or the in-flight information managing device 130.

The in-flight information managing device 130 is a device which is set in the passenger plane and stores passenger information (information concerning a boarding ticket of the passenger plane issued by the ticketing device 11) concerning a person who has finished the boarding procedure of the passenger plane. The in-flight information managing device 130 acquires the passenger information from the ticketing information managing device 13. The in-flight information managing device 130 acquires passenger information of each seat in the passenger plane from the ticketing information managing device 13. Further, the passenger information of each seat includes at least seat information required to specify a seat such as a seat number and a facial image (the first facial image) of a person who has finished the boarding procedure for this seat.

Furthermore, the in-flight information managing device 130 has at least a data communication function with respect to the ticketing information managing device 13 and a data communicating function with respect to the matching device 160. Moreover, the in-flight information managing device 130 may be provided with a communication function with respect to each camera 150 or the terminal device 170.

The camera 150 as a second biometric information acquiring section is set at each seat 140 in the passenger plane. As shown in FIG. 12, each camera 150 takes a facial image (a second facial image) as biometric information of the person (the passenger) M2 who has taken a seat behind a corresponding seat. Each camera 150 is mainly formed of, e.g., a video camera. Moreover, each camera 150 has at least a data communicating function with the matching device 160. Additionally, each camera 150 supplies seat information indicative of a seat shot and a facial image of a person who has taken this seat to the matching device 160.

The matching device 160 is a device which collates a facial image (the first facial image) of a person who has finished the boarding procedure with a facial image (the second facial image) of a person in each seat shot by the camera 150. The matching device 160 is provided with at least a data communicating function with respect to the in-flight information managing device 130 and a data communicating function with respect to each camera 150. Further, the matching device 160 is also provided with a communicating function with the terminal device. For example, when the terminal device 170 is a portable type information terminal device having a wireless communicating function, the matching device 160 is provided with an interface compatible with the wireless communicating function of the terminal device 170.

The matching device 160 acquires the information indicative of a seat and the second facial image from each camera 150. When the seat information and the second facial image are acquired from the camera 150, the matching device 160 acquires the first facial image (a facial image of a person who has finished the boarding procedure of a boarding ticket corresponding to this seat) corresponding to the seat information from the in-flight information managing device 130. As a result, the matching device 160 collates the second facial image shot by each camera 150 with the first facial image of the person who has finished the boarding procedure for the seat at which the second facial image has been taken.

The terminal device 170 is a terminal device possessed by an attendant in the passenger plane. The terminal device 170 is realized in the form of, e.g., a portable type information terminal device. Furthermore, the terminal device 170 has a communicating function with respect to the matching device 160. It is to be noted that the terminal device 170 may be provided with a communicating function with respect to the in-flight information managing device 130.

A structural example of each device constituting the admittance management system 3 will now be described.

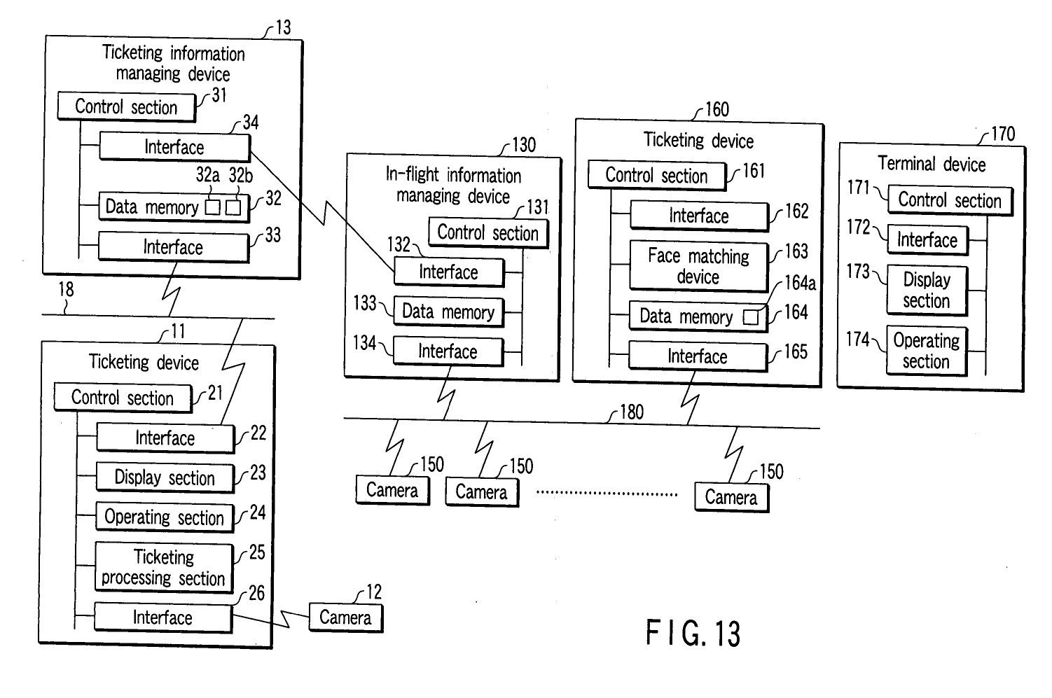

FIG. 13 is a block diagram schematically showing a structural example of each device constituting the admittance management system 3. As depicted in FIG. 13, in the admittance management system 3, the ticketing device 11, the camera 12 and the ticketing information managing device 13 are set on the outside of a passenger plane as the outside of the security area. The ticketing device 11 and the ticketing information managing device 13 are connected with each other through the network 18. Moreover, in the admittance management system 3, the in-flight information managing device 130, each camera 150 and the matching device 160 are set in a passenger plane as the security area. The in-flight information managing device 130, each camera 150 and the matching device 160 are connected with each other in a passenger plane through the local area network 180. Additionally, the in-flight information managing device 130 and the ticketing information managing device 13 have functions to perform data communication with each other. Further, the terminal device 170 capable of performing communication with the matching device 160 is possessed by an attendant in a passenger plane.

It is to be noted that, as shown in FIG. 13, the structures of the ticketing device 11 and the ticketing information managing device 13 are the same as those of the ticketing device 11 and the ticketing information managing device 13 of the admittance management system 1 according to the first embodiment depicted in FIG. 2, and hence like reference numerals are given to omit a detailed explanation thereof. However, in the admittance management system 3, the ticketing information managing device 13 is provided with an interface 34 as a communicating section for data communication with the in-flight information managing device 130 in addition to the structure depicted in FIG. 2.

A structural example of the in-flight information managing device 130 will now be described.

As shown in FIG. 13, the in-flight information managing device 130 has a control section 131, an interface 132, a data memory 133, an interface 134 and others.

The control section 131 controls the entire in-flight information managing device 130. The control section 131 is constituted of a CPU as an arithmetic operating section, an RAM and an ROM as memories, various kinds of interfaces which connect respective sections in the device, and others. The control section 131 is configured to realize various kinds of processing by executing a control program stored in memories. For example, the control section 131 has a function of retrieving information stored in the data memory 133 based on information serving as a retrieval key. Further, the control section 131 also has a function of retrieving a first facial image corresponding to a seat number and returning the first facial image as a result of this retrieval to the matching device 160 in response to a retrieval request of a facial image (the first facial image) of a person who has finished the boarding procedure of this seat based on the seat number from the matching device 160.

The interface 132 is an interface which performs data communication with the ticketing information managing device 13. The interface 132 may be a communicating section which effects data communication with the ticketing information managing device 13 through wireless communication or a communicating section which carries out data communication with the ticketing information managing device 13 through a line. The interface 132 is configured to download information (passenger information) concerning a passenger of a corresponding passenger plane from the ticketing information managing device 13.

The data memory 133 is formed of a high-capacity storage device such as a hard disk drive. The data memory 133 has a database 133a which stores passenger information of a corresponding passenger plane downloaded from the ticketing information managing device 13. The database 133a stores a facial image of a person who has performed a boarding procedure for a corresponding passenger plane and a seat number on a boarding ticket issued in the boarding procedure in associated with each other as the passenger information of this passenger plane. As a result, a first facial image can be retrieved based on a seat number in the passenger information stored in the database 133a.

The interface 134 is an interface which performs data communication with the matching device 160. Here, the interface 134 is configured to carry out data communication with the matching device 160 through the network 180.

A structural example of the matching device 160 will now be described.

As shown in FIG. 2, the matching device 160 has a control section 161, an interface 162, a face matching section 163, a data memory 164, an interface 165 and others.

The control section 161 controls the entire matching device 160. The control section 161 is constituted of a CPU as an arithmetic operating section, an RAM and an ROM as memories, various kinds of interfaces which connect respective sections in the device. The control section 161 is configured to realize various kinds of processing by executing a control program or the like stored in memories.

The interface 162 is an interface which performs data communication with the terminal device 170. The interface 162 functions as a communicating section which executes data communication in a communication mode corresponding to the communicating function provided to the terminal device 170. For example, the interface 162 is constituted of a wireless communication unit, and performs data communication with the terminal device 170 through wireless communication.

The face matching section 163 is a device which collates two facial images. That is, the face matching section 163 executes matching processing of judging whether two facial images correspond to the same person. The face matching section 163 carries out matching processing of a facial image (the first facial image) shot by the camera 12 and a facial image (the second facial image) shot by the camera 15. The second facial image is supplied together with a seat number from each camera 150. Furthermore, the first facial image is associated with boarding ticket information including at least a seat number and downloaded from the in-flight information managing device 130 as passenger information. That is, the first facial image can be retrieved by the ticketing information managing device 13 based on a seat number.

Moreover, the matching device 160 notifies the terminal device 170 of a result of face matching by the face matching section 163 through the interface 162 under control by the control section 161.

The data memory 164 is constituted of a high-capacity storage device such as a hard disk drive. The data memory 164 stores list data 164a consisting of information including at least a facial image concerning a specific person. The list data 164a is data stored in the data memory 164 in advance. Here, the specific person is, e.g., a marked person listed in a black list (e.g., a wanted list) or a white list (a list of, e.g., a passenger who requires a special service). That is, the list data 164a is used as a black list or a white list, and information including at least a facial image of a specific person is configured in a list form. It is to be noted that the list data 164a is the same as the list data 32b.

The interface 165 is an interface which performs data communication with each device (the in-flight information managing device 130 or each camera 150) through the network 180. That is, the interface 165 functions as a communicating section which executes data communication with each device.

A structural example of the terminal device 170 will now be described.

As shown in FIG. 13, the terminal device 170 has a control section 171, an interface 172, a display section 173, an operating section 174 and others.

The control section 171 controls the entire terminal device 170. The control section 171 is constituted of a CPU as an arithmetic operating section, an RAM and an ROM as memories, various kinds of interfaces which connect respective sections in the device. The control section 171 is configured to realize various kinds of processing by executing a control program or the like stored in memories.

The interface 172 is an interface which executes data communication with the matching device 160. The interface 172 is a communicating section which performs data communication in a communication mode corresponding to the communicating function provided to the matching device 160. For example, the interface 172 is constituted of a wireless communication unit, and performs data communication with the matching device 160 through wireless communication.

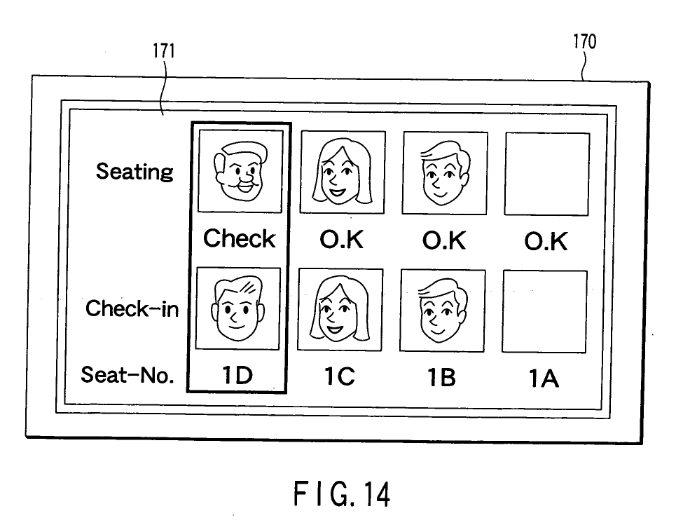

The display section 173 displays various kinds of guidance or the like. For example, when a result of matching of the first facial image and the second facial image about a passenger in each seat is received from the matching device 160, a result of face matching processing or the like is displayed in the display section 173. FIG. 14 shows a display example of a result of face matching processing in the display section 173. In the example depicted in FIG. 14, a matching result, the first facial image and the second facial image are displayed in accordance with each seat in the display section 173. In this manner, the display section 173 functions as a notifying section which notifies a matching result in each seat.

Furthermore, the operating section 174 inputs an operating instruction from an attendant who possesses the terminal device 170. The display section 173 and the operating section 174 are constituted of, e.g., a liquid crystal display device having a built-in touch panel.

It is to be noted that a hardware configuration of the admittance management system 3 can be modified in many ways in accordance with operating conformations and others. For example, the in-flight information managing device 130 and the matching device 160 may be configured as a single integrated device.

Processing in each device constituting the admittance management system 3 will now be described.

Boarding procedure processing by the ticketing device (a boarding procedure device) 11 will be first explained.

It is good enough for the boarding procedure processing by the ticketing device 11 in the admittance management system to be carried-out in the same manner as the processing explained in the first embodiment with reference to FIG. 3. Therefore, a detailed explanation of the boarding procedure processing by the ticketing device 11 will be omitted. It is to be noted that a facial image (the first facial image) of a person who has taken a boarding procedure shot by the camera 12 is stored in the database 32a in the ticketing information managing device 13 in association with issued boarding ticket information (a name of a passenger, information indicative of a passenger plane (a flight number), a seat number and others) in the boarding procedure processing by the ticketing device 11.

Passenger information transfer processing by the ticketing information managing device 13 will now be described.

As mentioned above, in the ticketing information managing device 13, passenger information is accumulated in the database 32a. The passenger information accumulated in the database 32a is transferred to the in-flight information managing device 130 of each passenger plane in accordance with each passenger plane. The ticketing information managing device 13 can appropriately transfer the passenger information of a corresponding passenger plane to the in-flight information managing device 130.

For example, the control section 31 of the ticketing information managing device 13 may transfer the passenger information to the in-flight information managing device 130 of a passenger plane identified by flight number information in the passenger information every time the passenger information is supplied from the ticketing device 11. Additionally, the control section 31 of the ticketing information managing device 13 may transfer the passenger information organized in accordance with each passenger plane to the in-flight information managing device 130 in each passenger plane at a predetermined time (e.g., a predetermined time ahead of a departure time of each passenger plane). Further, the control section 31 of the ticketing information managing device 13 may transfer the passenger information organized in accordance with each passenger plane to the in-flight information managing device 130 in response to a passenger information transfer request from the in-flight information managing device 130 of each passenger plane.

Furthermore, the in-flight information managing device 130 in each passenger plane receives the passenger information transferred from the ticketing information managing device 13 through the interface 132. The passenger information received through the interface 132 is accumulated in the data memory 133 of the in-flight information managing device 130 in each passenger plane. Moreover, the in-flight information managing device 130 can retrieve a first facial image corresponding to a seat number in response to a request from the matching device 160.

Face matching processing by the matching device 160 will now be described.

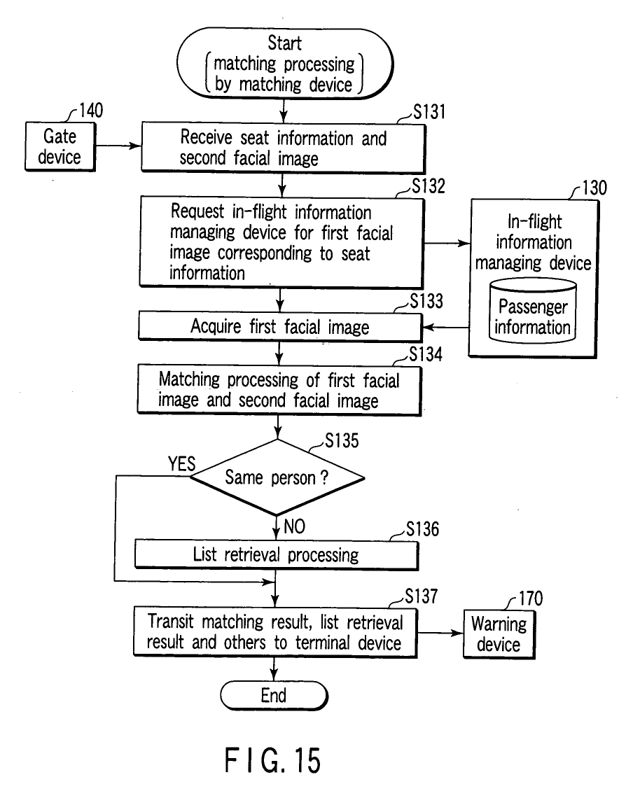

FIG. 15 is a flowchart illustrating the face matching processing by the matching device 160 in the admittance management system 3.

A passenger M2 who has taken the boarding procedure by the ticketing device 11 passes through a boarding gate to get on board a passenger plane. It is to be noted that, at the boarding gate, the passage control processing with respect to the passenger M2 may be executed like the first embodiment. The passenger M2 who has passed through the boarding gate to get on board the passenger plane takes a predetermined seat (a seat having a seat number written on a boarding ticket issued by the ticketing device 11) 140. Each camera 150 is configured to detect a person who has taken each corresponding seat.

That is, when the person (the passenger M2) takes the seat 140, the camera 150 corresponding to this seat 140 detects that the person has taken the seat 140 based on an image which is being shot. The camera 150 which has detected that the person has taken the seat shoots a facial image (the second facial image) of the person sitting in this seat. When the facial image of the passenger sitting in the seat is taken, the camera 150 transmits the shot facial image of the passenger together with the seat number of this seat to the matching device 160.

Upon receiving the seat number and the facial image (the second facial image) of the person sitting in this seat from the camera 150 (a step S131), the control section 161 of the matching device 160 performs processing of acquiring a first facial image (a facial image of a person who has taken the boarding procedure for this seat) corresponding to the received seat number from the in-flight information managing device 130 (steps S132 and S133). That is, when the second facial image and the seat number are received, the control section 160 of the matching device 160 requests the in-flight information managing device 130 to transmit the first facial image corresponding to this seat number (a step S132).

The control section 131 of the in-flight information managing device 130 which has been requested by the matching device 160 to transmit the first facial image corresponding to the seat number retrieves the first facial image corresponding to the seat number from the passenger information stored in the data memory 133. When the first facial image corresponding to the seat number is found by this retrieval, the control section 131 of the in-flight information managing device 130 transfers the first facial image corresponding to the seat number to the matching device 160. Additionally, when the first facial image corresponding to the seat number is not found by the retrieval, namely, when the passenger information of this seat number does not exist, the control section 131 of the in-flight information managing device 130 notifies the matching device 160 of a fact that the first facial image corresponding to the seat number does not exist.

When the first facial image corresponding to the seat number is received from the in-flight information managing device 130 (a step S133), the control section 161 of the matching device 160 performs the face matching processing of collating the first facial image acquired from the in-flight information managing device 130 with the second facial image received from the camera 150 together with the seat number by using the face matching section 163 (a step S134). This face matching processing is processing of judging whether the first facial image and the second facial image correspond to the same person.

For example, the face matching section 163 calculates a degree of similarity of the first facial image and the second facial image and compares the calculated degree of similarity with a preset threshold value like the face matching section 63 described in the first embodiment. When the calculated degree of similarity is not smaller than the threshold value as a result of this comparison, the face matching section 163 determines that the first facial image and the second facial image correspond to the same person (seem to correspond to the same person). Further, when the calculated degree of similarity is smaller than the threshold value as a result of the comparison, the face matching section 163 determines that the first facial image and the second facial image do not correspond to the same person (seem to not correspond to the same person).

That is, as a result of the above-described face matching processing, whether the first facial image and the second facial image correspond to the same person is obtained. Here, whether the first facial image and the second facial image correspond to the same person means whether the person who has taken the boarding procedure does not substitute for the person sitting in the seat. For example, when it is determined that the first facial image and the second facial image correspond to the same person, it can be decided that the person who has taken the boarding procedure is correctly sitting in a predetermined seat (a seat having a seat number written on a boarding ticket). This means that the person who has taken the boarding procedure does not substitute for the person sitting in the seat. On the contrary, when it is determined that the first facial image and the second facial image do not correspond to the same person, it can be decided that the person who has taken the boarding procedure is not sitting in a predetermined seat. This means that the person who has taken the boarding procedure substitutes for the person sitting in the seat.

It is to be noted that a result of the face matching processing may be stored in the storage device as history information. Consequently, it is possible to confirm a facial image of a person sitting in each seat or a facial image of a person who has taken a boarding procedure later.

When it is determined that the first facial image and the second facial image correspond to the same person by the face matching processing (the step S135, YES), the control section 161 of the matching device 160 transmits the seat number, the first facial image, the second facial image and others as information indicative of a result of the face matching to the terminal device 170 (a step S137).

Further, when it is determined that the first facial image and the second facial image do not correspond to the same person by the face matching processing (the step S135, NO), the control section 161 of the matching device 160 performs list retrieval processing with respect to the second facial image shot by the camera 150 (a step S136). This list retrieval processing is processing of retrieving a facial image matching with the second facial image from the list data 164a. It is to be noted that this list retrieval processing is the same as the processing described in the first embodiment with reference to FIG. 6, thereby omitting a detailed explanation thereof.

When it is determined that the first facial image and the second facial image do not correspond to the same person by the face matching processing and the list retrieval processing is executed, the control section 161 of the matching device 160 transmits a retrieval result of the list retrieval processing together with information indicative of the seat number and a result of face matching of the first facial image and the second facial image and others to the terminal device 170 (a step S137).

The terminal device 170 which has received the information indicative of the matching result displays the result of the face matching processing about each seat in the display section 173 like the display example depicted in FIG. 14. As a result, an attendant who possesses the terminal device 170 can immediately recognize a seat in which a person different from a person who has taken the boarding procedure is sitting, thus alleviating a work of monitoring persons in the passenger plane. Furthermore, the attendant who possesses the terminal device 170 can rapidly guide a person who is sitting a wrong seat to a correct seat.

Moreover, a result of the list retrieval processing may be also displayed in the display section 173 of the terminal device 170. For example, according to the processing procedure of the list retrieval processing shown in FIG. 6, a result of the list retrieval processing at the step S136 is an alignment of facial images registered in the list data 164a in descending order of degrees of similarity with respect to the second facial image. Therefore, facial images registered in the list data 164a which are aligned in descending order of degrees of similarity with respect to the second facial image can be displayed in the display section 173 of the terminal device 170.

In the admittance management system 3 according to the third embodiment, a facial image of a person who has taken the boarding procedure is stored as passenger information in association with seat information, and the passenger information is transferred to the information managing device in a passenger plane. Additionally, the admittance management system 3 is configured to shoot a facial image of a person who has taken each seat in a passenger plane, judges whether the facial image of a person sitting in each seat and a facial image of a person who has performed the boarding procedure for each seat correspond to the same person, and output a result of this judgment to the terminal device.

As a result, the terminal device can be informed of whether the person who has performed the boarding procedure is correctly sitting in each seat. Consequently, a fact that a person who has taken the boarding procedure is sitting in a seat by impersonating another person can be informed, thereby preventing the person who has taken the boarding procedure from getting on board the passenger plane as an impostor. Further, an attendant can rapidly guide a person who is sitting in a wrong seat.

A fourth embodiment will now be described.

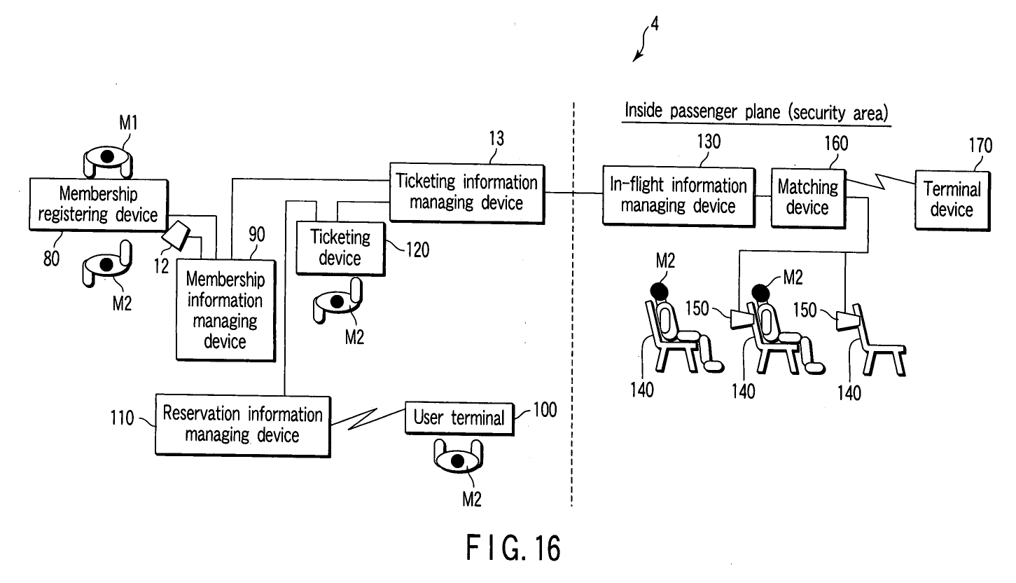

FIG. 16 schematically shows an entire configuration of an admittance management system 4 according to a fourth embodiment.

The admittance management system 4 shown in FIG. 16 is constituted of a camera 12, a ticketing information managing device 13, a membership registering device 80, a membership information managing device 90, a user terminal 100, a reservation information managing device 110, a ticketing device (a boarding procedure device) 120, an in-flight information managing device 130, a plurality of cameras 150, a matching device 160, a terminal device 170 and others. Incidentally, it is assumed that the inside of a passenger plane is a security area and persons who are in the passenger plane are monitored in the admittance management system 4 according to the fourth embodiment like the admittance management system 3 described in conjunction with the third embodiment.

Furthermore, in the admittance management system 4, processing by each device outside a passenger plane (processing or the like concerning a membership registration procedure, a reservation procedure and a boarding procedure) is the same as that of the admittance management system 2 according to the second embodiment. Moreover, in the admittance management system 4, processing by each device in a passenger plane (matching processing of a first facial image and a second facial image and others) is the same as that of the admittance management system 3 described in the third embodiment.

In other words, the admittance management system 4 according to the fourth embodiment is a combination of the admittance management system 2 according to the second embodiment and the admittance management system 3 according to the third embodiment. Therefore, in the admittance management system 4 according to the fourth embodiment shown in FIG. 16, like reference numerals denote devices equal to those in the admittance management system 2 according to the second embodiment depicted in FIG. 7 and devices equal to those in the admittance management system 3 according to the third embodiment illustrated in FIG. 12, thereby omitting a detailed explanation thereof. It is to be noted that the membership registering device 80, the membership information managing device 90, the user terminal 100, the reservation information managing device 110 and the ticketing device 120 have such configurations as shown in FIG. 8 in the admittance management system 4 depicted in FIG. 16. Moreover, the ticketing information managing device 13, the in-flight information managing device 130, the plurality of cameras 150, the matching device 160 and the terminal device 170 have such configurations as shown in FIG. 13 in the admittance management system 4 depicted in FIG. 16.

A description will now be given as to processing in each device constituting the admittance management system 4.

The membership registering device 80 performs a membership registration procedure of a user. Membership registration procedure processing by the membership registering device 80 is realized by the same processing as that described in the second embodiment with reference to FIG. 9. Therefore, a detailed explanation of the membership registration procedure processing by the membership registering device 80 in the admittance management system 4 will be omitted.

As described above, in the membership registration procedure processing by the membership registering device 80, a member card is issued with respect to a member, and membership information is registered in the membership information managing device 90.

The reservation information managing device 110 performs flight reservation processing of a passenger plane by using the user terminal 100 operated by a member who has been registered as a member. The flight reservation processing by the reservation information managing device 110 utilizing the user terminal 100 is realized by the same processing as that described in the second embodiment with reference to FIG. 10. Therefore, a detailed explanation of the flight reservation processing by the reservation information managing device 110 utilizing the user terminal 100 in the admittance management system 4 will be omitted.

As described above, in the flight reservation processing by the reservation information managing device 110 shown in FIG. 10, a flight reservation for a passenger plane is made in response to a request for the flight reservation from the user terminal 100 operated by a member. Moreover, when the flight reservation for the passenger plane is fixed, information concerning a member and information such as a flight number are stored in a database 92a as reservation information in the flight reservation processing by the reservation information managing device 110.

The ticketing device 120 carries out boarding procedure processing based on the reservation information of a member stored in the reservation information managing device 110. The boarding procedure processing based on the reservation information of a member by the ticketing device 120 is realized by the same processing as that described in the second embodiment with reference to FIG. 11. Therefore, a detailed explanation of the boarding procedure processing based on the reservation information of a member by the ticketing device 120 in the admittance management system 4 will be omitted.

As described above, in the boarding procedure processing based on the reservation information of a member by the ticketing device 120 shown in FIG. 11, the reservation information of this member is acquired from the reservation information managing device 110 based on information concerning the member obtained from a member card or the like owned by the member, and ticketing processing of a boarding ticket is carried out based on this reservation information. Additionally, in the boarding procedure processing based on the reservation information of the member by the ticketing device 120, a facial image (a first facial image) shot in the membership registration procedure of the member is acquired based on the information concerning the member, and the acquired first facial image is stored together with boarding ticket information (information including at least a flight number and seat information) of the issued boarding ticket as passenger information in the ticketing information managing device 13.

The ticketing information managing device 13 sorts the passenger information stored in a database 32a in accordance with each passenger plane and transfers each sorted information to the in-flight information managing device of each passenger plane as described in conjunction with the third embodiment.

The matching device 160 executes face matching processing of judging whether a facial image (here, a facial image (a first facial image) shot in the membership registration procedure) of a person who has taken the boarding procedure and a facial image (a second facial image) of a person who has taken each seat in a passenger plane correspond to the same person. The face matching processing by the matching device 160 is realized by the same processing as that described in the third embodiment with reference to FIG. 15. Therefore, a detailed explanation of the face matching processing by the matching device 160 in the admittance management system 4 will be omitted.

As described above, the face matching processing by the matching device 160 shown in FIG. 15 judges whether a facial image (here, a facial image (a first facial image) shot in the membership registration procedure) of a person who has taken the boarding procedure and a facial image (a second facial image) of a person who has taken each seat in a passenger plane correspond to the same person. Further, in the face matching processing by the matching device 160, a result of the face matching processing is transmitted to the terminal device 170. As a result, the terminal device 170 displays the first facial image, the second facial image, a matching result and others in accordance with each seat as a result of the face matching processing.

Furthermore, when it is determined that the first facial image and the second facial image do not belong to the same person, the matching device 160 carries out list retrieval processing with respect to the second facial image. The list retrieval processing by the matching device 160 is realized by the same processing as that described in the first embodiment with reference to FIG. 6. Therefore, a detailed explanation of the list retrieval processing by the matching device 160 in the admittance management system 4 will be omitted.

As described above, in the list retrieval processing by the matching device 160 shown in FIG. 15, when it is determined that the first facial image and the facial image (the second facial image) of a person who has taken each seat in a passenger plane do not correspond to the same person, there is carried out processing of judging a degree of similarity of the second facial image and each facial image registered in the list data 164a. As a result of this list retrieval, each facial image registered in the list data 164a aligned in the order of degrees of similarity with respect to the second facial image can be obtained. Moreover, in the list retrieval processing by the matching device 160, a result of the list retrieval is transmitted to the terminal device 170 together with a result of the face matching processing. Consequently, the terminal device 170 can also display a result of the list retrieval.

In the above-described admittance management system 4 according to the fourth embodiment, a facial image of a person who has performed the membership registration procedure is stored as membership information, and a flight reservation is accepted in the user terminal by this member. Additionally, in the admittance management system 4, a facial image of the person who has performed the boarding procedure shot in the membership registration procedure is associated with seat information as a facial image of the person who has performed the boarding procedure based on the accepted reservation information and stored as passenger information, and the passenger information is transferred to the information managing device in a passenger plane. Further, the admittance management system 4 shoots a facial image of a person who has taken each seat in the passenger plane, judges whether the facial image of the person sitting in each seat and the facial image of the person who has performed the boarding procedure correspond to the same person, and outputs a result of this judgment to the terminal device.

Consequently, in the admittance management system 4, even if a flight reservation is made in a ticketless mode using membership information including a facial image or the simplified boarding procedure is carried out by using the membership information including the facial image, the terminal device can be notified of whether the person who has performed the boarding procedure is correctly sitting in each seat.

Additional advantages and modifications will readily occur to those skilled in the art. Therefore, the invention in its broader aspects is not limited to the specific details and representative embodiments shown and described herein. Accordingly, various modifications may be made without departing from the spirit or scope of the general invention concept as defined by the appended claims and their equivalents.

What is claimed is:

1. An admittance management system comprising:
a ticketing section which issues an admission ticket to a security area;
a first biometric information acquiring section which acquires biometric information of a person who has performed a ticketing procedure of the admission ticket through the ticketing section;
a second biometric information acquiring section which acquires biometric information of a person who has approached a gate provided at an entrance to the security area;
a judging section which judges whether the biometric information acquired by the second biometric information acquiring section and the biometric information acquired by the first biometric information acquiring section correspond to the same person; and
a gate control section which allows the person to pass through the gate, when the judging section determines that the biometric information acquired by the second biometric information acquiring section and the biometric information acquired by the first biometric information acquiring section correspond to the same person.

2. The admittance management system according to claim 1, further comprising a membership registering section which performs a registration procedure as a member,
wherein the first biometric information acquiring section acquires biometric information of a person who has performed the registration procedure by the membership registering section.

3. The admittance management system according to claim 1, further comprising an notifying section which gives notification of a warning, when the judging section determines that the biometric information acquired by the second biometric information acquiring section and the biometric information acquired by the first biometric information acquiring section do not correspond to the same person.

4. The admittance management system according to claim 1, wherein the gate control section further prevents the person from passing through the gate, when the judging section determines that the biometric information acquired by the second biometric information acquiring section and the biometric information acquired by the first biometric information acquiring section do not correspond to the same person.

5. The admittance management system according to claim 1, wherein the judging section calculates a degree of similarity of the biometric information acquired by the second biometric information acquiring section and the biometric information acquired by the first biometric information acquiring section, determines that the pair of biometric information corresponds to the same person when the calculated degree of similarity is larger than a preset threshold value, and determines that the pair of biometric information does not correspond to the same person when the calculated degree of similarity is smaller than a preset value.

6. The admittance management system according to claim 1, further comprising:
a list in which biometric information of a specific person is registered in advance;
matching section which collates the biometric information registered in the list with biometric information acquired by the first biometric information acquiring section or the second biometric information acquiring section; and
matching result outputting section which outputs a matching result of the matching section.

7. The admittance management system according to claim 1, wherein the biometric information of the person is a facial image of the person.

8. An admittance management system comprising:
a ticketing section which issues an admission ticket to a security area;
a first biometric information acquiring section which acquires biometric information of a person who has performed a ticketing procedure of the admission ticket by the ticketing section;
a second biometric information acquiring section which acquires biometric information of a person existing at a predetermined position in the security area;
a judging section which judges whether the biometric information acquired by the second biometric information acquiring section and the biometric information acquired by the first biometric information acquiring section correspond to the same person; and
a notifying section which notifies that the person existing at the predetermined position in the security area is not the person whose biometric information has been acquired by the first biometric information acquiring section, when the judging section determines that the biometric information acquired by the second biometric information acquiring section and the biometric information acquired by the first biometric information acquiring section do not correspond to the same person.

9. The admittance management system according to claim 8, further comprising a membership registering section which performs a registration procedure as a member,
wherein the first biometric information acquiring section acquires biometric information of a person who has performed the registration procedure by the membership registering section.

10. The admittance management system according to claim 8, wherein the second biometric information acquiring section acquires a facial image of a person sitting in a seat specified by the admission ticket issued by the ticketing section, and
the notifying section notifies that a person sitting in a seat in the security area is not the person specified by the admission ticket issued by the ticketing section, when the judging section determines that the biometric information acquired by the second biometric information acquiring section and the biometric information acquired by the first biometric information acquiring section do not correspond to the same person.

11. The admittance management system according to claim 8, wherein the judging section calculates a degree of similarity of the biometric information acquired by the second biometric information acquiring section and the biometric information acquired by the first biometric information acquiring section, determines that the pair of biometric information corresponds to the same person when the calculated degree of similarity is larger than a preset threshold value, and determines that the pair of biometric information does not correspond to the same person when the calculated degree of similarity is smaller than the preset threshold value.

12. The admittance management system according to claim 8, further comprising:
a list in which biometric information of a specific person is registered in advance;
a matching section which collates the biometric information registered in the list with the biometric information acquired by the first biometric information acquiring section or the second biometric information acquiring section; and
a matching result outputting section which outputs a matching result of the matching section.

13. The admittance management system according to claim 8, wherein the biometric information of the person is a facial image of the person.

14. An admittance management method which manages admittance to a security area, comprising:
issuing an admission ticket to the security area;
acquiring biometric information of a person who has performed an issuing procedure of the admission ticket as first biometric information;
acquiring biometric information of a person who has approached a gate provided at an entrance to the security area as second biometric information;
judging whether the biometric information of the person who has approached the gate and the biometric information of the person who has performed the issuing procedure of the admission ticket correspond to the same person; and
allowing the person to pass through the gate when it is determined that the biometric information of the person who has approached the gate and the biometric information of the person who has performed the issuing procedure of the admission ticket correspond to the same person.

15. The admittance management method according to claim 14, further comprising performing a registration procedure as a member,
wherein acquiring the first biometric information acquires biometric information of a person who has performed the registration procedure as a member.

16. The admittance management method according to claim 14, further comprising preventing the person from passing through the gate when the judgment determines that the biometric information of the person who has approached the gate and the biometric information of the person who has performed the issuing procedure of the admission ticket do not correspond to the same person.

17. An admittance management method which manages admittance to a security area, comprising:
issuing an admission ticket to the security area;
acquiring biometric information of a person who has performed an issuing procedure of the admission ticket as first biometric information;
acquiring biometric information of a person existing at a predetermined position in the security area as second biometric information;
judging whether the biometric information of the person existing at the predetermined position in the security area and the biometric information of the person who has performed the issuing procedure of the admission ticket correspond to the same person; and
notifying that the person existing at the predetermined position in the security area is not the person who has performed the issuing procedure of the admission ticket when the judgment determines that the biometric information of the person existing at the predetermined position in the security area and the biometric information of the person who has performed the issuing procedure of the admission ticket do not correspond to the same person.

18. The admittance management method according to claim 17, further comprising performing a registration procedure as a member,
wherein acquiring the first biometric information acquires biometric information of a person who has performed the registration procedure as a member.

19. The admittance management method according to claim 17, wherein acquiring the second biometric information acquires a facial image of a person sitting in a seat specified by the admission ticket, and
notifying notifies that the person sitting in a seat in the security area specified by the admission ticket is not the person who has performed the issuing procedure of the admission ticket when the judgment determines that biometric information of the person sitting in the seat in the security area specified by the admission ticket and the biometric information of the person who has performed the issuing procedure of the admission ticket do not correspond to the same person.
